(19) United States
(12) Patent Application Publication
(10) Pub. No.: US 2025/0115703 A1
(43) Pub. Date: Apr. 10, 2025

(54) PROCESS FOR PREPARING A CARBODIIMIDE USING A SPECIFIC CATALYTIC COMPOUND COMPRISING A METAL M AND OXYGEN, WHEREIN THE METAL M IS ONE OR MORE OF MO AND W

(71) Applicant: BASF SE, Ludwigshafen am Rhein (DE)

(72) Inventors: Frederic Lucas, Ludwigshafen am Rhein (DE); Tobias Gienau, Waterloo (BE); Stephan Dohmen, Duesseldorf-Holthausen (DE); Lennart Karl Bernhard Garve, Ludwigshafen am Rhein (DE); Frank Schaefer, Lemfoerde (DE)

(73) Assignee: BASF SE, Ludwigshafen am Rhein (DE)

(21) Appl. No.: 18/727,374

(22) PCT Filed: Jan. 10, 2023
(86) PCT No.: PCT/EP2023/050471

§ 371 Date: Jul. 9, 2024

(30) Foreign Application Priority Data
Jan. 11, 2022 (EP) 22150919.3

(51) Int. Cl. C08G 18/22; C08G 18/28; C08G 18/75; C08G 18/76

(52) U.S. Cl. CPC C08G 18/222; C08G 18/283; C08G 18/758; C08G 18/765

(57) ABSTRACT

A process for preparing a carbodiimide includes (i) providing a mixture including one or more isocyanates and a catalytic compound, and (ii) subjecting the mixture obtained in (i) to reaction conditions in a gas atmosphere. The catalytic compound includes a metal and oxygen, wherein the metal is one or more of Mo and W. and at least a portion of the metal in the catalytic compound is bound to oxygen via one or more single bonds, via one or more double bonds, or via one or more single and double bonds. The reaction conditions in the gas atmosphere take place at a temperature in a range of from 45 to 220° C.

### TECHNICAL FIELD

The present invention relates to a process for preparing a carbodiimide, wherein the process comprises provision of a specific catalytic compound particularly comprising a metal M and oxygen, wherein at least a portion of the metal M is bound to oxygen via one or more single bonds, via one or more double bonds, or via one or more single and double bonds, and wherein M is one or more of Mo and W. Further, the present invention relates to a carbodiimide, obtained and/or obtainable by the inventive process, and use thereof.

### INTRODUCTION

Carbodiimides, preferably in their oligomeric or polymeric form as polycarbodiimides, are known compounds, which are used as stabilizers in plastics, in particular with respect to undesired degradation due to hydrolysis. In the context of the present invention the term polycarbodiimides includes oligomeric as well as polymeric forms thereof. For example, in particular thermoplastic polyurethanes or polyesters are typically stabilized with polycarbodiimides.

Generally, carbodiimides and also polycarbodiimides can be prepared by known methods, especially by elimination of carbon dioxide from monoisocyanates, oligoisocyanates or polyisocy-anates under catalytic conditions. In particular, two diisocyanates can react in an elimination reaction to a carbodiimide. Further elimination reaction(s) with additional isocyanates can lead to a carbodiimide of formula (I):

Q¹-[Q²⁻N═C═N]ₙ-Q³-Q⁴ (I)

wherein n is in the range of from 1 to 500, preferably in the range of from 2 to 20, more preferably in the range of from 3 to 15, more preferably in the range of from 4 to 10, and wherein Q² and Q³ stands for an organic backbone and Q¹ and Q⁴ stands for an organic end group, wherein n is typically in the range of from 1 to 500, preferably in the range of from 2 to 20, more preferably in the range of from 3 to 15, more preferably in the range of from 4 to 10, and wherein Q represents an organic backbone.

Said carbodiimidization reaction is typically run in the presence of a catalyst. Suitable catalysts include heterocyclic compounds containing phosphorus, e.g. phospholines, phospholenes and phospholidines and also their oxides and sulfides and/or metal carbonyls. Typical catalysts include phospholene oxides, in particular 1-methyl-2-phospholene-1-oxide or 3-Methyl-1-phenyl-2-phospholene 1-oxide.

For example, a typical hydrolysis stabilizer for thermoplastic polyurethanes (Elastostab) can be synthesized from tetramethyixylene diisocyanate (TMXDI), wherein the synthesis is homoge-nously catalyzed by 1-methyl-2-phospholene-1-oxide (MPO). However, the used phospholene oxide-containing catalyst is comparatively expensive and it has to be removed from the end-product, typically via distillation, in order to avoid any side reaction when formulated in thermoplastic polyurethanes.

U.S. Pat. No. 3,406,197 A relates to the use of transition metal carbonyl compounds as catalysts for con-verting isocyanates to carbodiimides and particularly discloses use of molybdenum hexacarbonyl or tungsten hexacarbonyl as catalyst.

JP S54 66656 A discloses a method for producing dicyclohexylcarbodiimide (DCC) heating CHI together with a catalyst at 150 to 250° C.

DE 198 14 169 A1 discloses a process of reacting at least one polyol (a) with at least one di- or polyisocyanate (such as MDI) (b) followed by carbodiimidization of the reaction product thereof using a catalyst.

U.S. Pat. No. 3,632,620 A discloses decomposition of carbodiimide using MoO₂/CuC₁₂ catalyst into respective isocyanate.

Thus, a need remains for a process for preparing a carbodiimide, preferably for preparing a carbodiimide having formula (I), avoiding the disadvantages of known processes, in particular with respect to resource and process efficiency. Further, the need remains for a process making use of less toxic catalytic compounds, which thus avoids using potentially harmful materials. Thus, the need remains for an improved process for preparing a carbodiimide, preferably for preparing a carbodiimide having formula (I), in particular as an alternative to existing processes.

### DETAILED DESCRIPTION

It was an object of the present invention to provide a novel process for preparing a carbodiimide, preferably for preparing a carbodiimide having formula (I), in particular avoiding the draw-backs of known processes. Thus, it was an object of the present invention to provide a novel process for preparing a carbodiimide, preferably for preparing a carbodiimide having formula (I), avoiding toxic catalytic compounds while particularly achieving a good selectivity towards the formation of a carbodiimide. Also, it was an object to provide such a process under reaction conditions allowing comparatively low temperatures while achieving excellent yields.

Surprisingly, it was found that a catalytic compound comprising a metal M and oxygen, wherein at least a portion of the metal M is bound to oxygen via one or more single bonds, via one or more double bonds, or via one or more single and double bonds, and wherein M is one or more of Mo and W, is an active catalyst for preparing a carbodiimide, preferably for preparing a carbodiimide having formula (I), via condensation of one or more isocyanates. Thus, a process for preparing a carbodiimide is provided, preferably for preparing a carbodiimide having formula (I), wherein the process comprises use of a catalytic compound which is less toxic than catalytic compounds of the prior art, especially in comparison with known carbonyl compounds, and which can be prepared in a cost efficient manner saving resources. Further, the present invention allows for homogeneous as well as heterogeneous processes.

The carbodiimides of the present invention display a high hydrolysis inhibition action and light stability. Further, the carbodiimides of the present invention have good compatibility with the polyaddition and polycondensation products containing ester groups, in particular with polyester urethane rubbers, and can also be homogeneously mixed with these materials in the melt without problems.

The carbodimides of the present invention are very suitable as acceptor for carboxyl compounds and are therefore preferably used as stabilizers against hydrolytic degradation of compounds containing ester groups, for example polymers containing ester groups, e.g. polycondensation products such as thermoplastic polyesters such as polyethylene terephthalate and polybutylene terephthalate, polyether esters, polyamides, polyesteramides, polycaprolactones and also unsaturated polyester resins and polyester esters, e.g. block copolymers of polyethylene terephthalate or polybutylene terephthalate and polycaprolactone, and polyaddition products, e.g. polyurethanes, polyureas and polyurethane-polyurea elastomers containing ester groups.

Owing to their good solubility in the formative components for preparing polyurethanes and their good compatibility with the polyurethanes formed, the carbodiimides of the present invention are particularly suitable as stabilizers against hydrolytic degradation of polyurethanes, preferably compact or cellular polyurethane elastomers and in particular thermoplastic polyurethanes, and also cellulose or compact elastomers.

### Process for Preparing a Carbodiimide

Therefore, the present invention relates to a process for preparing a carbodiimide, preferably for preparing a carbodiimide having formula (I):

Q¹-[Q²-N═C═N]ₙ-Q³-Q⁴ (I)

wherein n is in the range of from 1 to 500, preferably in the range of from 2 to 20, more preferably in the range of from 3 to 15, more preferably in the range of from 4 to 10, and wherein Q² and Q³ stands for an organic backbone and Q¹ and Q⁴ stands for an organic end group, the process comprising
(i) providing a mixture comprising one or more isocyanates and a catalytic compound; wherein the catalytic compound comprises a metal M and oxygen, wherein the metal M is one or more of Mo and W, and wherein at least a portion of the metal M comprised in the catalytic compound is bound to oxygen via one or more single bonds, via one or more double bonds, or via one or more single and double bonds;
(ii) subjecting the mixture obtained in (i) to reaction conditions in a gas atmosphere, wherein the reaction conditions comprise a temperature in the range of from 45 to 220° C.; and obtaining a mixture comprising the carbodiimide, preferably a mixture comprising the carbodiimide having formula (I).

### Catalytic Compound

It is preferred that from 90 to 100 mol-%, more preferably from 95 to 100 mol-%, more preferably from 99 to 100 mol-%, of the metal M comprised in the catalytic compound, calculated as elemental M, is bound to oxygen via one or more single bonds, via one or more double bonds, or via one or more single and double bonds.

It is preferred that at least a portion of the metal M comprised in the catalytic compound is bound to oxygen via one or more double bonds, more preferably via one or two double bonds, more preferably via two double bonds.

It is preferred that the metal M is in oxidation state +IV or +VI, more preferably in oxidation state +VI.

It is preferred that the catalytic compound comprises, more preferably consists of, one or more salts, wherein the one or more salts more preferably comprise one or more of an anionic complex of one or more atoms of the metal M, a cationic complex of one or more atoms of the metal M, a cationic oxidic compound of one or more atoms of the metal M, and an anionic oxidic compound of one or more atoms of the metal M, more preferably one or more of an anionic complex of one or more atoms of the metal M and an anionic oxidic compound of one or more atoms of the metal M.

It is preferred that the catalytic compound comprises a salt comprising a cation selected from the group consisting of ammonium (NH₄⁺), trimethylammonium (NH(CH₃)₃⁺), anilinium (C₆H₅NH₃⁺), the diammonium ion of ethylenediamine (H₃NCH₂CH₂NH₃²⁺), tetrabutylammonium (Bu₄N⁺), Li⁺, Na⁺, K⁺, Mg²⁺, Ca²⁺, Sr²⁺, Ba²⁺, and a mixture of two or more thereof,

more preferably selected from the group consisting of Li⁺, Na⁺, K⁺, and a mixture of two or more thereof,
wherein the catalytic compound more preferably comprises a salt comprising Li⁺.

It is preferred that the catalytic compound comprises an anionic or cationic complex of one or more atoms of the metal M, and wherein the complex further comprises one or more, optionally substituted, ligands L, more preferably one or two, optionally substituted, ligands L.

Two specific alternatives apply with respect to the number of atoms of the metal M of the catalytic compound, in the case where the catalytic compound comprises an anionic or cationic complex of one or more atoms of the metal M, and wherein the complex further comprises one or more, optionally substituted, ligands L, preferably one or two, optionally substituted, ligands L.

According to a first alternative, it is preferred that the catalytic compound comprises a complex, more preferably an anionic complex or a cationic complex, comprising a single atom of the metal M, wherein one or more ligands L independently from each other are coordinated to the single atom of the metal M,

wherein the one or more ligands L independently from each other more preferably comprise one or more of O and S, more preferably two O, or two S, or one O and one S, and
wherein the one or more ligands L independently from each other more preferably are coordinated to the single atom of the metal M via one O, or one S, or two O, or two S, or one O and one S, more preferably via two O or two S.

According to a second alternative, it is preferred that the catalytic compound comprises a complex, more preferably an anionic complex or a cationic complex, comprising two atoms of the metal M, wherein one or more ligands L independently from each other coordinate to two atoms of the metal M,

wherein the one or more ligands L independently from each other more preferably comprise one or more of O and S, more preferably two O, or two S, or one O and one S, and wherein the one or more ligands L independently from each other more preferably coordinate to the two atoms of the metal M via one O, or one S, or two O, or two S, or one O and one S, more preferably via two O, wherein the one or more ligands L more preferably are a bridging ligand.

Further in the case where the catalytic compound comprises an anionic or cationic complex of one or more atoms of the metal M, and wherein the complex further comprises one or more, optionally substituted, ligands L, preferably one or two, optionally substituted, ligands L, it is preferred that one or more ligands L independently from each other comprise a hydroxyl anion, wherein more preferably one, two, or three of the one or more ligands L independently from each other are a hydroxyl anion.

Further, three specific alternatives apply with respect to the one or more ligands L of the catalytic compound, in the case where the catalytic compound comprises an anionic or cationic complex of one or more atoms of the metal M, and wherein the complex further comprises one or more, optionally substituted, ligands L, more preferably one or two, optionally substituted, ligands L.

According to a first alternative, it is preferred that the one or more ligands L independently from each other are selected from the group consisting of 1,1-methanediolate, 1,1-thiomethanediolate, 1,1-dithiomethanediolate, formate, thioformate, dithioformate, 1,2-ethanediolate, 1,2-thioethanediolate, 1,2-dithioethanediolate, 1,3-propanediolate, 1,3-thiopropanediolate, 1,3-dithiopropanediolate, and a mixture of two or more thereof, more preferably from the group consisting of 1,1-methanediolate, 1,1-thiomethanediolate, 1,1-dithiomethanediolate, formate, thioformate, dithioformate, 1,2-ethanediolate, 1,2-thioethanediolate, 1,2-dithioethanediolate, and a mixture of two or more thereof, more preferably from the group consisting of formate, thioformate, dithioformate, 1,2-ethanediolate, 1,2-thioethanediolate, 1,2-dithioethanediolate, and a mixture of two or more thereof,

more preferably from the group consisting of formate, thioformate, dithioformate, 1,2-ethanediolate, 1,2-thioethanediolate, 1,2-dithioethanediolate, and a mixture of two or more thereof,
wherein the one or more ligands L more preferably are one or more of dithioformate and 1,2-ethanediolate.

In the case where one or more ligands L independently from each other are selected from the group consisting of 1,1-methanediolate, 1,1-thiomethanediolate, 1,1-dithiomethanediolate, formate, thioformate, dithioformate, 1,2-ethanediolate, 1,2-thioethanediolate, 1,2-dithioethanediolate, 1,3-propanediolate, 1,3-thiopropanediolate, 1,3-dithiopropanediolate, and a mixture of two or more thereof, it is preferred that the one or more ligands L are substituted with one or more substituents, more preferably with one or two substituents.

In the case where one or more ligands L are substituted with one or more substituents, preferably with one or two substituents, it is preferred that the one or more substituents are independently from each other selected from the group consisting of Oxo (═O), Thio (═S), hydroxyl, NR¹R², wherein R¹ and R² independently from each other are (C₁-C₆)alkyl, more preferably methyl, ethyl, n-propyl, or n-butyl, more preferably methyl, optionally substituted (C₁-C₁₂)alkyl, optionally substituted cycloaliphatic (C₅-C₁₀)alkyl, optionally substituted (C₆-C₉)aryl, optionally substituted (C₇-C₁₅)aralkyl, and optionally substituted (C₇-C₁₅)alkaryl,

more preferably selected from the group consisting of optionally substituted (C₁-C₈)alkyl, optionally substituted cycloaliphatic (C₅-C₆)alkyl, optionally substituted (C₆-C₉)aryl, optionally substituted (C₇-C₁₂)aralkyl, and optionally substituted (C₇-C₁₂)alkaryl,
more preferably selected from the group consisting of optionally substituted (C₁-C₆)alkyl, optionally substituted cycloaliphatic (C₅-C₆)alkyl, optionally substituted (C₆)aryl, and optionally substituted (C₇-C₁₀)alkaryl,
more preferably selected from the group consisting of optionally substituted (C₇-C₉)alkaryl,
wherein the optionally substituted (C₁-C₁₂)alkyl, the optionally substituted cycloaliphatic (C₅-C₁₀)alkyl, the optionally substituted (C₆-C₉)aryl, the optionally substituted (C₇-C₁₅)aralkyl, and the optionally substituted (C₇-C₁₅)alkaryl, are more preferably substituted with one or more of F, Cl, Br, I, OH, SH, and NR³R⁴, wherein R³ and R⁴ independently from each other are H, or (C₁-C₆)alkyl, more preferably methyl, ethyl, n-propyl, or n-butyl, more preferably methyl,
wherein one or more of the optionally substituted (C₁-C₁₂)alkyl, the optionally substituted cycloaliphatic (C₅-C₁₀)alkyl, the optionally substituted (C₆-C₉)aryl, the optionally substituted (C₇-C₁₅)aralkyl, and the optionally substituted (C₇-C₁₅)alkaryl, independently from each other are more preferably linear, branched, or cyclic, more preferably linear.

According to a second alternative, it is preferred that the catalytic compound comprises a complex, more preferably an anionic complex or a cationic complex, comprising a single atom of the metal M, wherein one or more ligands L independently from each other are coordinated to the single atom of the metal M,

wherein the one or more ligands L independently from each other more preferably comprise a carboxylate,
more preferably a carboxylate of an amino acid, wherein the amino acid is preferably selected from the group consisting of alanine, arginine, asparagine, aspartic acid, cysteine, glutamine, glutamic acid, glycine, histidine, isoleucine, leucine, lysine, methionine, proline, phenylalanine, serine, threonine, tryptophan, tyrosine, valine.

According to a third alternative, it is preferred that the catalytic compound comprises a complex,

more preferably an anionic complex or a cationic complex, comprising two atoms of the metal M, wherein one or more ligands L independently from each other coordinate to two atoms of the metal M,
wherein the one or more ligands L independently from each other more preferably comprise a carboxylate,
more preferably a carboxylate of an amino acid, wherein the amino acid is more preferably selected from the group consisting of alanine, arginine, asparagine, aspartic acid, cysteine, glutamine, glutamic acid, glycine, histidine, isoleucine, leucine, lysine, methionine, proline, phenylalanine, serine, threonine, tryptophan, tyrosine, valine.

Two specific alternatives apply with respect to the metal M of the catalytic compound.

According to a first alternative, it is preferred that the metal M is Mo.

In the case where the metal M is Mo, it is preferred that the catalytic compound comprises,

more preferably consists of, one or more of MoO₂ and MoO₃, wherein the catalytic compound more preferably comprises, more preferably consists of, MoO₃.

Further in the case where the metal M is Mo, it is preferred that the catalytic compound comprises a salt comprising a molybdate anion, optionally a hydrated molybdate anion, more preferably a molybdate anion selected from the group consisting of MoO₄²⁻, Mo₂O₇²⁻, Mo₃O₁₀²⁻, Mo₄O₁₃²⁻, Mo₅O₁₆²⁻, Mo₆O₁₉²⁻, Mo₇O₂₄⁶⁻, Mo₈O₂₆⁴⁻, and a mixture of two or more thereof, wherein the catalytic compound more preferably comprises MoO₄²⁻.

Further in the case where the metal M is Mo, it is preferred that the catalytic compound comprises, more preferably consists of, one or more of Li₂MoO₄, Na₂MoO₄, and K₂MoO₄, more preferably one or more of Li₂MoO₄ and K₂MoO₄, wherein the catalytic compound more preferably comprises, more preferably consists of, Li₂MoO₄.

Further in the case where the metal M is Mo, it is preferred that the catalytic compound comprises, more preferably consists of, one or more of Li₂MoO₄, K₂MoO₄, Na₂MoO₄, bis(diethyldithiocarbamato)-dioxomolybdenum(VI), potassium dioxobis[glycolato(2−)]-molybdate(VI), sodium dioxobis[methylglycolato(2−)]molybdate(VI), a dihydroxydi-μ-hydroxytetraoxodimolybdenum carboxylate, more preferably dihydroxydi-μ-hydroxytetraoxo-dimolybdenum 2-(Dimethylamino)-3-phenylpropanoate or dihydroxydi-μ-hydroxytetraoxo-dimolybdenum 2-amino-3-phenylpropanoate.

According to a second alternative, it is preferred that the metal M is W.

In the case where the metal M is W, it is preferred that the catalytic compound comprises, more preferably consists of, one or more of WO₂ and WO₃, wherein the catalytic compound more preferably comprises, more preferably consists of, WO₃.

Further in the case where the metal M is W, it is preferred that the catalytic compound compris-es a tungstate anion, optionally a hydrated tungstate anion, more preferably a tungstate anion WO₄²⁻.

It is preferred that from 95 to 100 weight-%, more preferably from 99 to 100 weight-%, more preferably from 99.9 to 100 weight-%, of the catalytic compound consist of the metal M, O, optionally H, optionally C, optionally N, and optionally S, preferably of the metal M, O, H, C, and N.

### Mixture Obtained in (i)

It is preferred that the mixture obtained in (i) comprises an amount in the range of from 0 to 5 mol-%, more preferably in the range of from 0 to 2.5 mol-%, more preferably in the range of from 0 to 2.0 mol-%, more preferably in the range of from 0 to 1.5 mol-%, more preferably in the range of from 0 to 1.0 mol-%, more preferably in the range of from 0 to 0.7 mol-%, more prefer-ably in the range of from 0 to 0.5 mol-%, more preferably in the range of from 0 to 0.2 mol-%, more preferably in the range of from 0 to 0.1 mol-%, more preferably in the range of from 0 to 0.05 mol-%, more preferably in the range of from 0 to 0.02 mol-%, more preferably in the range of from 0 to 0.01 mol-%, of a phospholene oxide, calculated as molar amount of the phospho-lene oxide, more preferably of a compound comprising a phosphorous oxygen double bond, calculated as molar amount of the compound comprising a phosphorous oxygen double bond, more preferably of a compound comprising P, calculated as molar amount of the compound comprising P, more preferably of P, calculated as elemental P, based on the amount of the one or more isocyanates, calculated as sum of the molar amounts of the one or more isocyanates, wherein the mixture obtained in (i) more preferably is essentially free of a phospholene oxide, more preferably of a compound comprising a phosphorous oxygen double bond, more preferably of a compound comprising P, and more preferably of P.

It is preferred that the mixture obtained in (i) comprises an amount in the range of from 0 to 5 mol-%, more preferably in the range of from 0 to 1.0 mol-%, more preferably in the range of from 0 to 0.1 mol-%, more preferably in the range of from 0 to 0.01 mol-%, of an alkali metal, calculated as elemental alkali metal, based on the amount of the one or more isocyanates, cal-culated as sum of the molar amounts of the one or more isocyanates, wherein the mixture ob-tained in (i) is more preferably essentially free of an alkali metal.

It is preferred that the mixture obtained in (i) comprises an amount in the range of from 0 to 5 mol-%, more preferably in the range of from 0 to 1.0 mol-%, more preferably in the range of from 0 to 0.1 mol-%, more preferably in the range of from 0 to 0.01 mol-%, of Mg, calculated as elemental Mg, more preferably of one or more of Mg and Ca, calculated as elemental Mg and elemental Ca, respectively, more preferably of one or more of Mg, Ca, and Ba, calculated as elemental Mg, as elemental Ca and elemental Ba, respectively, more preferably of one or more of an alkali earth metal, calculated as elemental alkali earth metal, based on the amount of the one or more isocyanates, calculated as sum of the molar amounts of the one or more isocya-nates, wherein the mixture obtained in (i) more preferably is essentially free of Mg, more prefer-ably of one or more of Mg and Ca, more preferably of one or more of Mg, Ca, and Ba, more preferably of one or more of an alkali earth metal.

### Isocyanates Comprised in the Mixture According to (i)

It is preferred that the one or more isocyanates comprised in the mixture according to (i) com-prise, more preferably consist of, one or more of a primary isocyanate, a secondary isocyanate and a tertiary isocyanate.

It is preferred that the one or more isocyanates comprised in the mixture according to (i) com-prise, more preferably consist of, one or more of a monoisocyanate and a diisocyanate.

It is preferred that the one or more isocyanates comprised in the mixture according to (i) com-prise, more preferably consist of, one or more of a primary monoisocyanate, a primary diisocya-nate, a secondary monoisocyanate, a secondary diisocyanate, a tertiary monoisocyanate, and a tertiary diisocyanate, wherein the one or more isocyanates more preferably comprise, more preferably consist of, one or more of a secondary diisocyanate and a tertiary diisocyanate.

It is preferred that the one or more isocyanates comprised in the mixture according to (i) com-prise, more preferably consist of, an isocyanate, more preferably a primary monoisocyanate, a secondary monoisocyanate or a tertiary monoisocyanate, having the formula (II):

OCN—C(R⁶,R⁷)—R⁸—C(R⁹,R¹⁰)—R¹¹ (II),

wherein R⁶ and R⁷ independently from one another are H or alkyl, wherein the alkyl is more preferably linear or branched, more preferably linear,
wherein R⁶ and R⁷ independently from one another more preferably are (C₁-C₂₂)alkyl, more preferably (C₁-C₁₆)alkyl, more preferably (C₁-C₁₂)alkyl, more preferably (C₁-C₅)alkyl, more preferably (C₁-C₆)alkyl, more preferably (C₁-C₅)alkyl, more preferably (C₁-C₄)alkyl,
wherein R⁶ and R⁷ independently from one another more preferably are methyl, ethyl, propyl, isopropyl, n-butyl, sec-butyl, isobutyl, or tert-butyl, more preferably methyl,
wherein R⁹ and R¹⁰ independently from one another is H or alkyl, wherein the alkyl is more preferably linear or branched, more preferably linear,
wherein R⁹ and R¹⁰ independently from one another more preferably are H or (C₁-C₂₂)alkyl, more preferably (C₁-C₁₆)alkyl, more preferably (C₁-C₁₂)alkyl, more preferably (C₁-C₅)alkyl, more preferably (C₁-C₆)alkyl, more preferably (C₁-C₅)alkyl, more preferably (C₁-C₄)alkyl,
wherein R⁹ and R¹⁰ independently from one another more preferably are H, methyl, ethyl, pro-pyl, isopropyl, n-butyl, sec-butyl, isobutyl, or tert-butyl, more preferably methyl,
wherein R⁸ is alkylene, alkarylene, aralkylene, or arylene, wherein the one or more of the al-kylene, the alkarylene, the aralkylene, and the arylene is more preferably linear, branched or cyclic,
wherein R⁸ is more preferably selected from the group consisting of (C₁-C₁₆)alkylene, cycloali-phatic (C₅-C₂₀)alkylene, (C₆-C₁₈)arylene, (C₇-C₂₀)aralkylene, and (C₇-C₂₀)alkarylene, preferably selected from the group consisting of (C₁-C₅)alkylene, cycloaliphatic (C₅-C₁₀)alkylene, (C₆-C₉)arylene, (C₇-C₁₅)aralkylene, and (C₇-C₁₅)alkarylene, more preferably selected from the group consisting of (C₁-C₆)alkylene, (C₅-C₆)alkylene, (C₆)arylene, (C₇-C₁₂)aralkylene, and (C₇-C₁₂)alkarylene, more preferably selected from the group consisting of (C₃-C₆)alkylene, (C₇-C₁₀)aralkylene, and (C₇-C₁₀)alkarylene, more preferably selected from the group consisting of (C₇-C₉)aralkylene, and (C₇-C₉)alkarylene, wherein R⁸ is more preferably selected from the group consisting of (C₈-C₉)aralkylene, and (C₈-C₉)alkarylene,
wherein R⁸ is more preferably selected from the group consisting of methylene, ethylene, tri-methylene, tetramethylene, pentamethylene, hexamethylene, ortho-phenylene, meta-phenylene, and para-phenylene,
wherein R⁸ is more preferably selected from the group consisting of pentamethylene, hexa-methylene, ortho-phenylene, meta-phenylene, and para-phenylene,
wherein R⁸ more preferably is para-phenylene,
wherein R¹¹ is selected from the group consisting of isopropenyl, NCNR¹², NHCONHR¹³, NHCONR¹⁴R¹⁵, and NHCOOR¹⁶,
wherein R¹² is one or more of (C₁-C₁₈)alkylene, (C₅-C₁₈)cycloalkylene, arylene, (C₇-C₁₈)alkarylene and (C₇-C₁₈)aralkylene, more preferably one or more of (C₇-C₁₈)alkylarylene and (C₇-C₁₈)aralkylene,
wherein R¹³, R¹⁴, R¹⁵, and R¹⁶ independently from one another are selected from the group con-sisting of alkyl, cycloalkyl, alkaryl, aralkyl, a polyester group, a polyamide group, and —(CH₂)ₕ—O—[(CH₂)ₖ—O]_{g}—R¹⁷,
wherein h is in the range of from 1 to 3, k is in the range of from 1 to 3, g is in the range of from 0 to 12, and wherein R¹⁷ is H or (C₁-C₄)alkyl,
wherein R¹³, R¹⁴, R¹⁵, and R¹⁶ independently from one another are more preferably selected from the group consisting of (C₁-C₁₂)alkyl, cycloaliphatic (C₅-C₁₀)alkyl, (C₆-C₉)aryl, (C₇-C₁₅)aralkyl, and (C₇-C₁₅)alkaryl, wherein one or more of the (C₁-C₁₂)alkyl, cycloaliphatic (C₅-C₁₀)alkyl, (C₆-C₉)aryl, (C₇-C₁₅)aralkyl, and (C₇-C₁₅)alkaryl independently from each other prefer-ably are linear, branched, or cyclic, more preferably linear,
more preferably selected from the group consisting of (C₁-C₅)alkyl, cycloaliphatic (C₅-C₆)alkyl, (C₆-C₉)aryl, (C₇-C₁₂)aralkyl, and (C₇-C₁₂)alkaryl,
more preferably selected from the group consisting of (C₁-C₆)alkyl, cycloaliphatic (C₅-C₆)alkyl, and (C₆)aryl,
more preferably selected from the group consisting of (C₁-C₅)alkyl,
more preferably selected from the group consisting of (C₁-C₄)alkyl,
wherein more preferably R¹³, R¹⁴, R¹⁵, and R¹⁶ independently from one another are methyl, ethyl, propyl, isopropyl, n-butyl, sec-butyl, isobutyl, or tert-butyl.

It is preferred that the one or more isocyanates comprised in the mixture according to (i) comprises, more preferably consists of, an isocyanate, more preferably a tertiary diisocyanate, hav-ing the formula (III):

OCN—C(R¹⁸,R¹⁹)—R²⁰—C(R²¹,R²²)—NCO (III),

wherein R¹⁸, R¹⁹, R²¹ and R²² independently from one another are alkyl, wherein the alkyl more preferably is linear or branched,
wherein R¹⁸, R¹⁹, R²¹ and R²² independently from one another more preferably are (C₁-C₂₂)alkyl,
more preferably (C₁-C₁₆)alkyl, more preferably (C₁-C₁₂)alkyl, more preferably (C₁-C₈)alkyl, more preferably (C₁-C₆)alkyl, more preferably (C₁-C₅)alkyl, more preferably (C₁-C₄)alkyl,
wherein R¹⁸, R¹⁹, R²¹ and R²² independently from one another more preferably are methyl, ethyl, propyl, isopropyl, n-butyl, sec-butyl, isobutyl, or tert-butyl, more preferably methyl,
wherein R²⁰ is alkylene, alkarylene, aralkylene, or arylene, wherein one or more of the alkylene, the alkarylene, the aralkylene, and the arylene independently from each other are linear, branched or cyclic, more preferably linear,
wherein R²⁰ is more preferably selected from the group consisting of (C₁-C₁₅)alkylene, cycloali-phatic (C₅-C₂₀)alkylene, (C₆-C₁₈)arylene, (C₇-C₂₀)aralkylene, and (C₇-C₂₀)alkarylene, more preferably selected from the group consisting of (C₁-C₈)alkylene, cycloaliphatic (C₅-C₁₀)alkylene, (C₆-C₉)arylene, (C₇-C₁₅)aralkylene, and (C₇-C₁₅)alkarylene, more preferably selected from the group consisting of (C₁-C₆)alkylene, (C₅-C₆)alkylene, (C₆)arylene, (C₇-C₁₂)aralkylene, and (C₇-C₁₂)alkarylene, more preferably selected from the group consisting of (C₃-C₆)alkylene, (C₇-C₁₀)aralkylene, and (C₇-C₁₀)alkarylene, more preferably selected from the group consisting of (C₇-C₉)aralkylene, and (C₇-C₉)alkarylene, wherein R²⁰ is more preferably selected from the group consisting of (C₈-C₉)aralkylene, and (C₈-C₉)alkarylene,
wherein R²⁰ is more preferably selected from the group consisting of methylene, ethylene, tri-methylene, tetramethylene, pentamethylene, hexamethylene, ortho-phenylene, meta-phenylene, and para-phenylene,
wherein R²⁰ more preferably is selected from the group consisting of pentamethylene, hexa-methylene, ortho-phenylene, meta-phenylene, and para-phenylene,
wherein R²⁰ more preferably is para-phenylene.

In the case where the one or more isocyanates comprised in the mixture according to (i) comprises, more preferably consists of, an isocyanate, more preferably a tertiary diisocyanate, hav-ing the formula (III):

OCN—C(R¹⁸,R¹⁹)—R²⁰—C(R²¹,R²²)—NCO (III),

wherein R¹⁸, R¹⁹, R²¹ and R²² independently from one another are alkyl, wherein the alkyl more preferably is linear or branched,
wherein R²⁰ is alkylene, alkarylene, aralkylene, or arylene, wherein one or more of the alkylene, the alkarylene, the aralkylene, and the arylene independently from each other are linear, branched or cyclic, more preferably linear, it is preferred that the one or more isocyanates com-prised in the mixture according to (i) comprises, more preferably consists of, a tertiary diisocya-nate, more preferably 1,3-bis(1-methyl-1-isocyanatoethyl)-benzene.

It is preferred that the one or more isocyanates comprised in the mixture according to (i) comprises from 10 to 44 weight-%, more preferably from 15 to 40 weight-%, more preferably from 32 to 37 weight-%, of NCO, based on the amount of the one or more isocyanates, more prefer-ably of the amount of the one or more tertiary isocyanates, calculated as sum of the weights of the one or more isocyanates, more preferably of the sum of the weights of the one or more ter-tiary isocyanates.

It is preferred that the one or more isocyanates comprised in the mixture according to (i) com-prise, more preferably consist of, an isocyanate, more preferably a tertiary monoisocyanate, having the formula (IV):

OCN—C(R²⁵,R²⁶)—R²⁷—C(R²⁸,R²⁹)—R³⁰ (IV),

wherein R²⁵ and R²⁶ independently from one another is alkyl, wherein the alkyl is more preferably linear or branched, more preferably linear,
wherein R²⁵ and R²⁶ independently from one another more preferably is (C₁-C₂₂)alkyl, more preferably (C₁-C₁₆)alkyl, more preferably (C₁-C₁₂)alkyl, more preferably (C₁-C₈)alkyl, more preferably (C₁-C₆)alkyl, more preferably (C₁-C₅)alkyl, more preferably (C₁-C₄)alkyl,
wherein R²⁵ and R²⁶ independently from one another more preferably are methyl, ethyl, propyl, isopropyl, n-butyl, sec-butyl, isobutyl, or tert-butyl, more preferably methyl,
wherein R²⁸ and R²⁹ independently from one another are H or alkyl, wherein the alkyl is more preferably linear or branched, more preferably linear,
wherein R²⁸ and R²⁹ independently from one another more preferably are H or, (C₁-C₂₂)alkyl,
more preferably (C₁-C₁₆)alkyl, more preferably (C₁-C₁₂)alkyl, more preferably (C₁-C₈)alkyl, more preferably (C₁-C₆)alkyl, more preferably (C₁-C₅)alkyl, more preferably (C₁-C₄)alkyl,
wherein R²⁸ and R²⁹ independently from one another more preferably are H, methyl, ethyl, pro-pyl, isopropyl, n-butyl, sec-butyl, isobutyl, or tert-butyl, more preferably methyl,
wherein R²⁷ is alkylene, alkarylene, aralkylene, or arylene, wherein one or more of the alkylene, the alkarylene, the aralkylene, and the arylene independently from each other are branched or cyclic,
wherein R²⁷ is more preferably selected from the group consisting of (C₁-C₁₆)alkylene, cycloali-phatic (C₅-C₂₀)alkylene, (C₆-C₁₈)arylene, (C₇-C₂₀)aralkylene, and (C₇-C₂₀)alkarylene, more preferably selected from the group consisting of (C₁-C₈)alkylene, cycloaliphatic (C₅-C₁₀)alkylene, (C₆-C₉)arylene, (C₇-C₁₅)aralkylene, and (C₇-C₁₅)alkarylene, more preferably selected from the group consisting of (C₁-C₆)alkylene, (C₅-C₆)alkylene, (C₆)arylene, (C₇-C₂)aralkylene, and (C₇-C₁₂)alkarylene, more preferably selected from the group consisting of (C₃-C₆)alkylene, (C₇-C₁₀)aralkylene, and (C₇-C₁₀)alkarylene, more preferably selected from the group consisting of (C₇-C₉)aralkylene, and (C₇-C₉)alkarylene, wherein R²⁷ is more preferably selected from the group consisting of (C₈-C₉)aralkylene, and (C₈-C₉)alkarylene,
wherein R²⁷ is more preferably selected from the group consisting of methylene, ethylene, tri-methylene, tetramethylene, pentamethylene, hexamethylene, ortho-phenylene, meta-phenylene, and para-phenylene,
wherein R²⁷ more preferably is selected from the group consisting of pentamethylene, hexa-methylene, ortho-phenylene, meta-phenylene, and para-phenylene,
wherein R²⁷ more preferably is para-phenylene,
wherein R³⁰ is selected from the group consisting of isopropenyl, NCNR³¹, NHCONHR³², NHCONR³³R³⁴, and NHCOOR³⁵,
wherein R³¹ is (C₁-C₁₈)alkylene, (C₅-C₁₈)cycloalkylene, arylene, (C₇-C₁₈)alkarylene or (C₇-C₁₈)aralkylene, more preferably (C₇-C₁₈)alkylarylene or (C₇-C₁₈)aralkylene, wherein R³², R³³, R³⁴, and R³⁵ independently from one another are selected from the group con-sisting of alkyl, cycloalkyl, alkaryl, aralkyl, a polyester group, a polyether group, a polyamide group, and —(CH₂)ₕ—O—[(CH₂)ₖ-0]_{g}-R³⁶,
wherein h is in the range of from 1 to 3, k is in the range of from 1 to 3, g is in the range of from 0 to 12, and wherein R³⁶ is H or (C₁-C₄)alkyl, wherein R³², R³³, R³⁴, and R³⁵ independently from one another is more preferably selected from the group consisting of (C₁-C₁₂)alkyl, cycloaliphatic (C₅-C₁₀)alkyl, (C₆-C₅)aryl, (C₇-C₁₅)aralkyl, and (C₇-C₁₅)alkaryl, wherein one or more of the (C₁-C₁₂)alkyl, cycloaliphatic (C₅-C₁₀)alkyl, (C₆-C₉)aryl, (C₇-C₁₅)aralkyl, and (C₇-C₁₅)alkaryl independently from each other are linear, branched, or cyclic, more preferably linear,
more preferably selected from the group consisting of (C₁-C₈)alkyl, cycloaliphatic (C₅-C₆)alkyl, (C₆-C₉)aryl, (C₇-C₁₂)aralkyl, and (C₇-C₁₂)alkaryl,
more preferably selected from the group consisting of (C₁-C₆)alkyl, cycloaliphatic (C₅-C₆)alkyl, and (C₆)aryl,
more preferably selected from the group consisting of (C₁-C₅)alkyl,
more preferably selected from the group consisting of (C₁-C₄)alkyl,
wherein more preferably R³², R³³, R³⁴, and R³⁵ independently from one another are methyl, ethyl, propyl, isopropyl, n-butyl, sec-butyl, isobutyl, or tert-butyl.

In the case where the one or more isocyanates comprised in the mixture according to (i) com-prise, preferably consist of, an isocyanate, preferably a tertiary monoisocyanate, having the formula (IV):

OCN—C(R²⁵,R²⁶)—R²⁷—C(R²⁸,R²⁹)—R³⁰ (IV),

wherein R²⁵ and R²⁶ independently from one another is alkyl, wherein the alkyl is preferably lin-ear or branched, more preferably linear,
wherein R²⁸ and R²⁹ independently from one another are H or alkyl, wherein the alkyl is preferably linear or branched, more preferably linear,
wherein R²⁷ is alkylene, alkarylene, aralkylene, or arylene, wherein one or more of the alkylene, the alkarylene, the aralkylene, and the arylene independently from each other are branched or cyclic,
wherein R³⁰ is selected from the group consisting of isopropenyl, NCNR³¹, NHCONHR³², NHCONR³³R³⁴, and NHCOOR³⁵,
wherein R³¹ is (C₁-C₁₈)alkylene, (C₅-C₁₈)cycloalkylene, arylene, (C₇-C₁₈)alkarylene or (C₇-C₁₈)aralkylene, preferably (C₇-C₁₈)alkylarylene or (C₇-C₁₈)aralkylene,
wherein R³², R³³, R³⁴, and R³⁵ independently from one another are selected from the group con-sisting of alkyl, cycloalkyl, alkaryl, aralkyl, a polyester group, a polyether group, a polyamide group, and —(CH₂)ₕ—O—[(CH₂)ₖ-0]_{g}-R³⁶,
wherein h is in the range of from 1 to 3, k is in the range of from 1 to 3, g is in the range of from 0 to 12, and wherein R³⁶ is H or (C₁-C₄)alkyl, it is preferred that R³⁰ is NHCOOR³⁵ wherein R³⁵ is a polyether group, wherein R³⁵ is more preferably O—(R⁴⁰—O)ₘ—R⁴¹,
wherein R⁴⁰ is an alkylene group,
wherein R⁴⁰ is more preferably selected from the group consisting of methylene, ethylene, tri-methylene, tetramethylene, pentamethylene, hexamethylene, ortho-phenylene, meta-phenylene, para-phenylene,
wherein R⁴⁰ more preferably is ethylene,
wherein R⁴¹ is alkyl, wherein the alkyl is more preferably linear or branched, more preferably linear,
wherein R⁴¹ more preferably is (C₁-C₂₂)alkyl, more preferably (C₁-C₁₈)alkyl, more preferably par-tially unsaturated (C₁-C₁₈)alkyl, more preferably (C₁-C₁₆)alkyl, more preferably (C₁-C₁₂)alkyl,
more preferably (C₁-C₈)alkyl, more preferably (C₁-C₆)alkyl, more preferably (C₁-C₅)alkyl, more preferably (C₁-C₄)alkyl,
wherein R⁴¹ more preferably is methyl, ethyl, propyl, isopropyl, n-butyl, sec-butyl, isobutyl, or tert-butyl, more preferably methyl, and
wherein m is an integer of 0 to 150, more preferably an integer of 2 to 150, preferably an integer of 5 to 100, more preferably an integer of 7 to 50, more preferably an integer of 8 to 25, more preferably an integer of 9 to 20, more preferably an integer of 10 to 15.

In the case where R³⁰ is NHCOOR³⁵, and wherein R³⁵ is O—(R⁴⁰—O)ₘ—R⁴¹, it is preferred that R⁴¹ is substituted alkyl, wherein the substituted alkyl more preferably comprises one or more sub-stituents, wherein the one or more substituents of the substituted alkyl independently from each other are more preferably selected from the group consisting of (C₁-C₃)alkoxy, hydroxyl, amino, halides, and combinations of two or more thereof, more preferably from the group consisting of (C₁-C₂)alkoxy, hydroxyl, amino, chloro, bromo, fluoro, and combinations of two or more thereof,

more preferably from the group consisting of hydroxyl, amino, chloro, and combinations thereof,
wherein more preferably the one or more substituents independently from each other are hy-droxyl,
wherein the substituted alkyl preferably comprises one or more substituents, more preferably one to four substituents, more preferably 1one to three substituents, more preferably one or two substituents, wherein the substituted alkyl more preferably comprises one substituent.

Further in the case where R³⁰ is NHCOOR³⁵, and wherein R³⁵ is O—(R⁴⁰—O)ₘ—R⁴¹, it is preferred that R⁴¹ is a partially unsaturated alkyl, wherein R⁴¹ more preferably comprises one or more,

more preferably from one to five, more preferably from one to three, more preferably one, C═C double bonds.

Further in the case where R³⁰ is NHCOOR³⁵, and wherein R³⁵ is O—(R⁴⁰—O)ₘ—R⁴¹, it is preferred that m=0,

wherein R⁴¹ is alkyl, wherein the alkyl is more preferably partially unsaturated, wherein the alkyl is more preferably substituted,
wherein R⁴¹ more preferably is (C₁-C₂₂)alkyl, more preferably (C₁₂-C₂₂)alkyl, more preferably partially unsaturated (C₁₂-C₂₂)alkyl, more preferably partially unsaturated (C₁₆-C₂₀)alkyl, more preferably partially unsaturated (C₁₈-C₁₉)alkyl, wherein R⁴¹ preferably comprises one or more,
more preferably from one to five, more preferably from one to three, more preferably one, C—C double bonds, and wherein R⁴¹ more preferably is (2)-Octadec-9-en-yl (oleyl).

It is preferred that the one or more isocyanates comprises, preferably consists of, an aliphatic monoisocyanate or an aliphatic diisocyanate,

wherein the aliphatic monoisocyanate is more preferably selected from the group consisting of (C₁-C₂₀)alkylene monoisocyanates, and a mixture of two or more thereof, more preferably from the group consisting of (C₃-C₁₈)alkylene monoisocyanates, and a mixture of two or more thereof, more preferably from the group consisting of (C₆-C₁₃)alkylene monoisocyanates, and a mixture of two or more thereof,
wherein the aliphatic diisocyanate is more preferably selected from the group consisting of a (C₁-C₂₀)alkylene diisocyanates, and a mixture of two or more thereof, more preferably from the group consisting of (C₃-C₁₈)alkylene diisocyanates, and a mixture of two or more thereof, more preferably from the group consisting of (C₆-C₁₃)alkylene diisocyanates, and a mixture of two or more thereof,
wherein the aliphatic diisocyanate is more preferably selected from the group consisting of 1,6-diisocyanatohexane (HDI), 1-isocyanato-4-[(4-isocyanatocyclohexyl)methyl]cyclohexane (4,4′-diisocyanato dicyclohexylmethane; H12MDI), 5-isocyanato-1-(isocyanatomethyl)-1,3,3-trimethylcyclohexane (isophorone diisocyanate; IPDI), and a mixture of two or more thereof,
wherein the aliphatic diisocyanate more preferably is 1-isocyanato-4-[(4-isocyanatocyclohexyl)methyl]cyclohexane (4,4′-diisocyanato dicyclohexylmethane; H12MDI).

It is preferred that the one or more isocyanates comprised in the mixture according to (i) com-prise, more preferably consist of, a tertiary monoisocyanate, more preferably 3-isopropenyl-alpha,alpha-dimethylbenzyl isocyanate (TMI).

It is preferred that the one or more isocyanates comprised in the mixture according to (i) com-prise, more preferably consist of, an aromatic isocyanate, more preferably one or more of 1,3-diisopropyl-2-isocyanato benzene, 1,3,5-triisopropyl-2,4-diisocyanato benzene, and 1,3-Bis(2-isocyanatopropan-2-yl)benzene, more preferably 1,3-Bis(2-isocyanatopropan-2-yl)benzene.

It is preferred that Q¹ and Q⁴ independently from each other are —NCO or R¹¹ or R³⁰, and

wherein Q² and Q³ independently from each other are —C(R⁶,R⁷)—R⁸—C(R⁹,R¹⁰)— or —C(R¹⁸,R¹⁹)—R²⁰—C(R²¹,R²²)— or —C(R²⁵,R²⁶)—R²⁷—C(R²⁸,R²⁹)—,
wherein R⁶ and R⁷ are defined as in any one of the embodiments hereinabove,
wherein R⁸ is defined as in any one of the embodiments hereinabove,
wherein R⁹ and R¹⁰ are defined as in any one of the embodiments hereinabove,
wherein R¹¹ is defined as in any one of the embodiments hereinabove,
wherein R¹⁸ and R¹⁹ are defined as in any one of the embodiments hereinabove,
wherein R²⁰ is defined as in any one of the embodiments hereinabove,
wherein R²¹ and R²² are defined as in any one of the embodiments hereinabove,
wherein R²⁵ and R²⁶ are defined as in any one of the embodiments hereinabove,
wherein R²⁷ is defined as in any one of the embodiments hereinabove,
wherein R²⁸ and R²⁹ are defined as in any one of the embodiments hereinabove,
wherein R³⁰ is defined as in any one of the embodiments hereinabove.

### Reaction Conditions According to (ii)

It is preferred that the reaction conditions in (ii) comprise a temperature in the range of from 50 to 220° C., more preferably in the range of from 60 to 200° C., more preferably in the range of from 80 to 180° C., more preferably in the range of from 130 to 180° C., more preferably in the range of from 150 to 180° C.

It is preferred that the gas atmosphere in (ii) comprises, more preferably consists of, an inert gas, wherein the gas atmosphere in (ii) more preferably comprises, more preferably consists of, one or more of nitrogen and argon.

It is preferred that the reaction conditions in (ii) comprise a pressure in the range of from 1 to 1000 hPa(abs), more preferably in the range of from 2 to 1000 hPa(abs), more preferably in the range of from 2.5 to 1000 hPa(abs).

It is preferred that the reaction conditions in (ii) comprise agitating the mixture obtained in (i),

more preferably stirring the mixture obtained in (i).

It is preferred that the mixture obtained in (i) is subjected to the reaction conditions in (ii) for a duration in the range of from 1 to 50 h, more preferably in the range of from 1.5 to 40 h, more preferably in the range of from to 2 to 25 h.

It is preferred that the mixture according to (i) is provided in a reactor, wherein the reactor more preferably comprises a reactor vessel or a tubular reactor.

It is preferred that the mixture provided in (i) further comprises a first end-capping agent, wherein the first end-capping agent has the formula (V):

HX—(R⁴⁴—Y)ₙ—R⁴⁵ (V),

wherein X is O, S, or NR⁴², wherein R⁴² is alkyl, wherein the alkyl is preferably linear or branched, more preferably linear, wherein X is preferably O,
wherein R⁴² is more preferably (C₁-C₂₂)alkyl, more preferably (C₁-C₁₈)alkyl, more preferably par-tially unsaturated (C₁-C₁₈)alkyl, more preferably (C₁-C₁₆)alkyl, more preferably (C₁-C₁₂)alkyl,
more preferably (C₁-C₈)alkyl, more preferably (C₁-C₆)alkyl, more preferably (C₁-C₅)alkyl, more preferably (C₁-C₄)alkyl,
wherein R⁴² more preferably is methyl, ethyl, propyl, isopropyl, n-butyl, sec-butyl, isobutyl, or tert-butyl, more preferably methyl,
wherein Y is O, S, or NR⁴³, wherein R⁴³ is alkyl, wherein the alkyl is more preferably linear or branched, more preferably linear, wherein X is more preferably O,
wherein R⁴³ is more preferably (C₁-C₂₂)alkyl, more preferably (C₁-C₁₈)alkyl, more preferably par-tially unsaturated (C₁-C₁₈)alkyl, more preferably (C₁-C₁₆)alkyl, more preferably (C₁-C₁₂)alkyl,
more preferably (C₁-C₈)alkyl, more preferably (C₁-C₆)alkyl, more preferably (C₁-C₅)alkyl, more preferably (C₁-C₄)alkyl,
wherein R⁴³ more preferably is methyl, ethyl, propyl, isopropyl, n-butyl, sec-butyl, isobutyl, or tert-butyl, more preferably methyl,
wherein R⁴⁴ is an alkylene group,
wherein R⁴⁴ is more preferably selected from the group consisting of methylene, ethylene, tri-methylene, tetramethylene, pentamethylene, hexamethylene, ortho-phenylene, meta-phenylene, and para-phenylene,
wherein R⁴⁴ more preferably is ethylene,
wherein R⁴⁵ is alkyl, wherein the alkyl is preferably linear or branched, more preferably linear,
wherein R⁴⁵ is more preferably (C₁-C₂₂)alkyl, more preferably (C₁-C₁₈)alkyl, more preferably par-tially unsaturated (C₁-C₁₈)alkyl, more preferably (C₁-C₁₆)alkyl, more preferably (C₁-C₁₂)alkyl,
more preferably (C₁-C₈)alkyl, more preferably (C₁-C₆)alkyl, more preferably (C₁-C₅)alkyl, more preferably (C₁-C₄)alkyl,
wherein R⁴⁵ more preferably is methyl, ethyl, propyl, isopropyl, n-butyl, sec-butyl, isobutyl, or tert-butyl, more preferably methyl, and
wherein n is an integer of 0 to 150, more preferably an integer of 2 to 150, preferably an integer of 5 to 100, more preferably an integer of 7 to 50, more preferably an integer of 8 to 25, more preferably an integer of 9 to 20, more preferably an integer of 10 to 15,
wherein the first end-capping agent more preferably is a methylpolyethylene glycol.

In the case where the mixture provided in (i) further comprises a first end-capping agent, wherein the first end-capping agent has the formula (V):

HX—(R⁴⁴—Y)ₙ—R⁴⁵ (V),

wherein X is O, S, or NR⁴², wherein R⁴² is alkyl, wherein Y is O, S, or NR⁴³, wherein R⁴³ is alkyl,
wherein R⁴⁴ is an alkylene group, wherein R⁴⁵ is alkyl, and wherein n is an integer of 0 to 150, it is preferred that R⁴⁵ is substituted alkyl, wherein the substituted alkyl preferably comprises one or more substituents, wherein the one or more substituents of the substituted alkyl independent-ly from each other are more preferably selected from the group consisting of (C₁-C₃)alkoxy, hy-droxyl, amino, halides, and combinations of two or more thereof, more preferably from the group consisting of (C₁-C₂)alkoxy, hydroxyl, amino, chloro, bromo, fluoro, and combinations of two or more thereof, more preferably from the group consisting of hydroxyl, amino, chloro, and combi-nations thereof, wherein more preferably the one or more substituents independently from each other are hydroxyl,
wherein the substituted alkyl group more preferably comprises one or more substituents, preferably 1 to 4 substituents, more preferably 1 to 3 substituents, more preferably 1 or 2 substitu-ents, wherein the substituted alkyl group more preferably comprises 1 substituent.

Further in the case where the mixture provided in (i) further comprises a first end-capping agent,

wherein the first end-capping agent has the formula (V):

HX—(R⁴⁴—Y)ₙ—R⁴⁵ (V),

wherein X is O, S, or NR⁴², wherein R⁴² is alkyl, wherein Y is O, S, or NR⁴³, wherein R⁴³ is alkyl,
wherein R⁴⁴ is an alkylene group, wherein R⁴⁵ is alkyl, and wherein n is an integer of 0 to 150, it is preferred that R⁴⁵ is partially unsaturated alkyl, wherein R⁴⁴ more preferably comprises one or more, more preferably from one to five, more preferably from one to three, more preferably one, C═C double bonds.

Further in the case where the mixture provided in (i) further comprises a first end-capping agent,

wherein the first end-capping agent has the formula (V):

HX—(R⁴⁴—Y)ₙ—R⁴⁵ (V),

wherein X is O, S, or NR⁴², wherein R⁴² is alkyl, wherein Y is O, S, or NR⁴³, wherein R⁴³ is alkyl,
wherein R⁴⁴ is an alkylene group, wherein R⁴⁵ is alkyl, and wherein n is an integer of 0 to 150, it is preferred that n=0,
wherein R⁴⁵ is alkyl, wherein the alkyl is more preferably partially unsaturated, wherein the alkyl is more preferably substituted,
wherein R⁴⁵ more preferably is (C₁-C₂₂)alkyl, more preferably (C₁₂-C₂₂)alkyl, more preferably partially unsaturated (C₁₂-C₂₂)alkyl, more preferably partially unsaturated (C₁₆-C₂₀)alkyl, more preferably partially unsaturated (C₁₈-C₁₉)alkyl, wherein R⁴⁵ more preferably comprises one or more, more preferably from one to five, more preferably from one to three, more preferably one, C═C double bonds, and wherein R⁴⁵ more preferably is (2)-Octadec-9-en-yl (oleyl).

It is preferred that the mixture provided in (i) further comprises a first end-capping agent, wherein the first end-capping agent has the formula (VI):

HX—R⁴⁷ (VI)

wherein X is O, S, or NR⁴⁶,
wherein R⁴⁶ and R⁴⁷ independently from each other is alkyl, wherein the alkyl is more preferably linear or branched, more preferably linear, wherein X is more preferably NR⁴⁶,
wherein R⁴⁶ and R⁴⁷ independently from each other more preferably is (C₁-C₂₂)alkyl, more preferably (C₁-C₁₈)alkyl, more preferably partially unsaturated (C₁-C₁₈)alkyl, more preferably (C₁-C₁₆)alkyl, more preferably (C₁-C₁₂)alkyl, more preferably (C₁-C₅)alkyl, more preferably (C₁-C₆)alkyl, more preferably (C₁-C₅)alkyl, more preferably (C₁-C₄)alkyl,
wherein R⁴⁶ and R⁴⁷ independently from each other more preferably is methyl, ethyl, propyl, isopropyl, n-butyl, sec-butyl, isobutyl, or tert-butyl, more preferably methyl.

In the case where the mixture provided in (i) further comprises a first end-capping agent, wherein the first end-capping agent has the formula (V) or (VI) as defined hereinabove, it is preferred that the first end-capping agent has an average molecular mass in the range of from 100 to 5500 daltons, more preferably in the range of from 200 to 3300 daltons, more preferably in the range of from 300 to 2200 daltons, more preferably in the range of from 400 to 1100 daltons,

more preferably in the range of from 400 to 800 daltons, more preferably in the range of from 450 to 550 daltons.

Further in the case where the mixture provided in (i) further comprises a first end-capping agent,

wherein the first end-capping agent has the formula (V) or (VI) as defined hereinabove, it is preferred that X is O, and wherein the first end-capping agent exhibits a hydroxyl number in the range of from 5 to 200 mg(KOH)/g, more preferably in the range of from 15 to 175 mg(KOH)/g,
more preferably in the range of from 45 to 145 mg(KOH)/g, more preferably in the range of from 75 to 130 mg(KOH)/g, more preferably in the range of from 100 to 120 mg(KOH)/g, wherein the hydroxyl number is more preferably determined according to DIN 53240.

Further in the case where the mixture provided in (i) further comprises a first end-capping agent,

wherein the first end-capping agent has the formula (V) or (VI) as defined hereinabove, it is preferred that the first end-capping agent exhibits viscosity in the range of from 5 to 200 mm²/s,
more preferably in the range of from 15 to 175 mm²/s, more preferably in the range of from 45 to 145 mm²/s, more preferably in the range of from 75 to 130 mm²/s, more preferably in the range of from 100 to 120 mm²/s, wherein the viscosity is more preferably determined at a temperature in the range of from 15 to 25° C., more preferably at a temperature of 19 to 21° C., more preferably at a temperature of 20° C., wherein the viscosity is more preferably determined according to DIN 51562.

Further in the case where the mixture provided in (i) further comprises a first end-capping agent,

wherein the first end-capping agent has the formula (V) or (VI) as defined hereinabove, it is preferred that the first end-capping agent comprises an amount of water in the range of from 0 to 1 weight-%, more preferably in the range of from 0 to 0.6 weight-%, more preferably in the range of from 0 to 0.55 weight-%, based on the weight of the first end-capping agent, wherein the wa-ter content is more preferably determined according to EN 13267.

It is preferred that a molar ratio of the one or more isocyanates comprised in the mixture ob-tained in (i), calculated as sum of the molar amounts of the one or more isocyanates, to the cat-alytic compound comprised in the mixture obtained in (i), calculated as molar amount of the cat-alytic compound, in the mixture obtained in (i) is in the range of from 1:5 to 100:1, more preferably in the range of from 1:3 to 75:1, more preferably in the range of from 1:2 to 50:1, more preferably in the range of from 1:1 to 10:1, more preferably in the range of from 2:1 to 8:1, more preferably in the range of from 4:1 to 7:1.

It is preferred that the mixture obtained in (i) comprises the catalytic compound in an amount in the range of from 0.1 to 100 mol-%, more preferably in the range of from 0.25 to 75 mol-%,

more preferably in the range of from 0.5 to 50 mol-%, more preferably in the range of from 0.75 to 40 mol-%, more preferably in the range of from 1 to 36 mol-%, based on the amount of the one or more isocyanates comprised in the mixture obtained in (i), calculated as sum of the mo-lar amounts of the one or more isocyanates comprised in the mixture obtained in (i).

It is preferred that the mixture obtained in (i) comprises the catalytic compound in an amount in the range of from 1 to 35 weight-%, more preferably in the range of from 2 to 31 weight-%, more preferably in the range of from 3 to 30 weight-%, based on the amount of the one or more iso-cyanates comprised in the mixture obtained in (i), calculated as sum of the weights of the one or more isocyanates comprised in the mixture obtained in (i).

It is preferred that the mixture obtained in (i) comprises an amount in the range of from 0 to 25 weight-%, more preferably in the range of from 0.1 to 10 weight-%, more preferably in the range of from 1 to 5 weight-%, of xylene, preferably of an alkyl substituted benzene or an alkyl substituted dibenzene, wherein the alkyl comprises one or more of methyl, ethyl, and propyl, more preferably of a solvent, based on the weight of the mixture obtained in (i),

wherein the mixture obtained in (i) is more preferably essentially free of xylene, more preferably of an alkyl substituted benzene or an alkyl substituted dibenzene, wherein the alkyl comprises one or more of methyl, ethyl, and propyl, more preferably of a solvent.

It is preferred that the mixture obtained in (i) comprises an amount in the range of from 0 to 5 weight-%, more preferably in the range of from 0.1 to 1 weight-%, of a primary diisocyanate, preferably of a primary isocyanate, based on the weight of the mixture obtained in (i), wherein the mixture provided in (i) is more preferably essentially free of a primary diisocyanate, preferably of a primary isocyanate.

It is preferred that the mixture obtained in (ii) comprises a residual amount of the one or more isocyanates in the range of from 0 to 35 mol-%, more preferably in the range of from 1 to 20 mol-%, more preferably in the range of from 5 to 15 mol-%, based on the amount of the one or more isocyanates comprised in the mixture obtained in (i), calculated as sum of the one or more isocyanates comprised in the mixture obtained in (i).

It is preferred that the process further comprises
(iii) cooling the mixture obtained in (ii) to a temperature in the range of from 0 to less than 45° C., preferably in the range of from 10 to 25° C.

Cooling the mixture obtained in (ii) according to (iii) can be carried out especially for inhibiting further carbodiimidization, preferably for inhibiting any further reaction.

It is preferred that the process further comprises
(iv) subjecting the mixture obtained in (ii) or (iii) to distillation conditions in a gas atmosphere, wherein the distillation conditions comprise a boiling point of the one or more isocyanates comprised in the mixture obtained in (i).

Subjecting the mixture obtained in (ii) or (iii) to distillation conditions in a gas atmosphere according to (iv) can be carried out especially for separating at least a portion of the one or more isocyanates from the mixture, and preferably for degradation of at least a portion of the catalytic compound.

In the case where the process further comprises (iv) as defined hereinabove, it is preferred that the distillation conditions comprise a temperature in the range of from 170 to 210° C., more preferably in the range of from 180 to 200° C.

Further in the case where the process further comprises (iv) as defined hereinabove, it is preferred that the distillation conditions comprise a pressure in the range of from 1 to 250 hPa(abs),

more preferably in the range of from 5 to 150 hPa(abs), more preferably in the range of from 5 to 10 hPa(abs).

Further in the case where the process further comprises (iv) as defined hereinabove, it is preferred that the mixture obtained in (iv) comprises an amount of isocyanate groups, calculated as NCO, in the range of from 0 to 10.5 weight-%, more preferably in the range of from 0 to 8.0 weight-%, based on the weight of the mixture obtained in (iv).

Further in the case where the process further comprises (iv) as defined hereinabove, it is preferred that the process further comprises
(v) recycling a portion of one or more isocyanates obtained in (iv) into (i).

It is preferred that the process further comprises
(vi) mixing the carbodiimide obtained in (ii), (iii), or (iv) with a second end-capping agent;
(vii) subjecting the mixture obtained in (vi) in a gas atmosphere to end-capping conditions, for obtaining a carbodiimide comprising one or more end-caps;
   wherein the second end-capping agent according to (vi) more preferably comprises one or more hydroxyl groups.

In the case where the process further comprises (vi) and (vii) as defined hereinabove, it is preferred that the second end-capping agent according to (vi) has the formula (VII):

HX—(R⁵⁰—Y)ₙ—R⁵¹ (VII),

wherein X is O, S, or NR⁴⁸, wherein R⁴⁸ is alkyl, wherein the alkyl is more preferably linear or branched, more preferably linear, wherein X is more preferably O,
wherein R⁴⁸ is more preferably (C₁-C₂₂)alkyl, more preferably (C₁-C₁₈)alkyl, more preferably par-tially unsaturated (C₁-C₁₈)alkyl, more preferably (C₁-C₁₈)alkyl, more preferably (C₁-C₁₂)alkyl,
more preferably (C₁-C₈)alkyl, more preferably (C₁-C₆)alkyl, more preferably (C₁-C₅)alkyl, more preferably (C₁-C₄)alkyl,
wherein R⁴⁸ more preferably is methyl, ethyl, propyl, isopropyl, n-butyl, sec-butyl, isobutyl, or tert-butyl, more preferably methyl,
wherein Y is O, S, or NR⁴⁹, wherein R⁴⁹ is alkyl, wherein the alkyl is preferably linear or branched, more preferably linear, wherein X is more preferably O,
wherein R⁴⁹ is more preferably (C₁-C₂₂)alkyl, more preferably (C₁-C₁₈)alkyl, more preferably par-tially unsaturated (C₁-C₁₈)alkyl, more preferably (C₁-C₁₆)alkyl, more preferably (C₁-C₁₂)alkyl,
more preferably (C₁-C₈)alkyl, more preferably (C₁-C₆)alkyl, more preferably (C₁-C₅)alkyl, more preferably (C₁-C₄)alkyl,
wherein R⁴⁹ more preferably is methyl, ethyl, propyl, isopropyl, n-butyl, sec-butyl, isobutyl, or tert-butyl, more preferably methyl,
wherein R⁵⁰ is an alkylene group,
wherein R⁵⁰ is more preferably selected from the group consisting of methylene, ethylene, tri-methylene, tetramethylene, pentamethylene, hexamethylene, ortho-phenylene, meta-phenylene, and para-phenylene,
wherein R⁵⁰ more preferably is ethylene,
wherein R⁵¹ is alkyl, wherein the alkyl is more preferably partially unsaturated, wherein the alkyl is more preferably substituted,
wherein R⁵¹ more preferably is alkyl, wherein the alkyl is more preferably linear or branched,
more preferably linear,
wherein R⁵¹ more preferably is (C₁-C₂₂)alkyl, more preferably (C₁-C₁₈)alkyl, more preferably par-tially unsaturated (C₁-C₁₈)alkyl, more preferably (C₁-C₁₆)alkyl, more preferably (C₁-C₁₂)alkyl,
more preferably (C₁-C₈)alkyl, more preferably (C₁-C₆)alkyl, more preferably (C₁-C₅)alkyl, more preferably (C₁-C₄)alkyl,
wherein R⁵¹ more preferably is methyl, ethyl, propyl, isopropyl, n-butyl, sec-butyl, isobutyl, or tert-butyl, more preferably methyl, and
wherein n is an integer of 0 to 150, more preferably an integer of 2 to 150, preferably an integer of 5 to 100, more preferably an integer of 7 to 50, more preferably an integer of 8 to 25, more preferably an integer of 9 to 20, more preferably an integer of 10 to 15,
wherein the second end-capping agent according to (vi) more preferably is a methylpolyeth-ylene glycol.

In the case where the second end-capping agent according to (vi) has the formula (VII):

HX—(R⁵⁰—Y)ₙ—R⁵¹ (VII),

wherein X is O, S, or NR⁴⁸, wherein R⁴⁸ is alkyl, wherein Y is O, S, or NR⁴⁹, wherein R⁴⁹ is alkyl,
wherein R⁵⁰ is an alkylene group, wherein R⁵¹ is alkyl, and wherein n is an integer of 0 to 150, it is preferred that R⁵¹ is substituted alkyl, wherein the substituted alkyl more preferably comprises one or more substituents, wherein the one or more substituents of the substituted alkyl independently from each other are more preferably selected from the group consisting of (C₁-C₃)alkoxy, hydroxyl, amino, halides, and combinations of two or more thereof, more preferably from the group consisting of (C₁-C₂)alkoxy, hydroxyl, amino, chloro, bromo, fluoro, and combina-tions of two or more thereof, more preferably from the group consisting of hydroxyl, amino, chlo-ro, and combinations thereof, wherein more preferably the one or more substituents independently from each other are hydroxyl,
wherein the substituted alkyl more preferably comprises one or more substituents, preferably one to four substituents, more preferably one to three substituents, more preferably one or two substituents, wherein the substituted alkyl group more preferably comprises one substituent.

Further in the case where the second end-capping agent according to (vi) has the formula (VII):

HX—(R⁵⁰—Y)ₙ—R⁵¹ (VII),

wherein X is O, S, or NR⁴⁸, wherein R⁴⁸ is alkyl, wherein Y is O, S, or NR⁴⁹, wherein R⁴⁹ is alkyl,
wherein R⁵⁰ is an alkylene group, wherein R⁵¹ is alkyl, and wherein n is an integer of 0 to 150, it is preferred that R⁵¹ is partially unsaturated alkyl, wherein R⁵¹ more preferably comprises one or more, more preferably from one to five, more preferably from one to three, more preferably one, C═C double bonds.

Further in the case where the second end-capping agent according to (vi) has the formula (VII):

HX—(R⁵⁰—Y)ₙ—R⁵¹ (VII),

wherein X is O, S, or NR⁴⁸, wherein R⁴⁸ is alkyl, wherein Y is O, S, or NR⁴⁹, wherein R⁴⁹ is alkyl,
wherein R⁵⁰ is an alkylene group, wherein R⁵¹ is alkyl, and wherein n is an integer of 0 to 150, it is preferred that n=0,
wherein R⁵¹ is alkyl, wherein the alkyl is more preferably partially unsaturated, wherein the alkyl is more preferably substituted,
wherein R⁵¹ is more preferably (C₁-C₂₂)alkyl, more preferably (C₁₂-C₂₂)alkyl, more preferably partially unsaturated (C₁₂-C₂₂)alkyl, more preferably partially unsaturated (C₁₆-C₂₀)alkyl, more preferably partially unsaturated (C₁₈-C₁₉)alkyl, wherein R⁵¹ preferably comprises one or more,
more preferably from one to five, more preferably from one to three, more preferably one, C═C double bonds, and wherein R⁵¹ more preferably is (2)-Octadec-9-en-yl (oleyl).

Further in the case where the second end-capping agent according to (vi) has the formula (VII):

HX—(R⁵⁰—Y)ₙ—R⁵¹ (VII),

wherein X is O, S, or NR⁴⁸, wherein R⁴⁸ is alkyl, wherein Y is O, S, or NR⁴⁹, wherein R⁴⁹ is alkyl,
wherein R⁵⁰ is an alkylene group, wherein R⁵¹ is alkyl, and wherein n is an integer of 0 to 150, it is preferred that the mixture provided in (i) further comprises a first end-capping agent, wherein the first end-capping agent has the formula (VIII):

HX—R⁵³ (VIII)

wherein X is O, S, or NR⁵²,
wherein R⁵² and R⁵³ independently from each other is alkyl, wherein X is preferably NR⁵²,
wherein R⁵² and R⁵³ independently from each other more preferably is (C₁-C₂₂)alkyl, more preferably (C₁-C₁₈)alkyl, more preferably partially unsaturated (C₁-C₁₈)alkyl, more preferably (C₁-C₁₆)alkyl, more preferably (C₁-C₁₂)alkyl, more preferably (C₁-C₈)alkyl, more preferably (C₁-C₆)alkyl, more preferably (C₁-C₅)alkyl, more preferably (C₁-C₄)alkyl,
wherein R⁵² and R⁵³ independently from each other more preferably is methyl, ethyl, propyl, isopropyl, n-butyl, sec-butyl, isobutyl, or tert-butyl, more preferably methyl.

In the case where the process further comprises (vi) and (vii) as defined hereinabove, it is preferred that the second end-capping agent according to (vi) has an average molecular mass in the range of from 100 to 5500 daltons, more preferably in the range of from 200 to 3300 daltons, more preferably in the range of from 300 to 2200 daltons, more preferably in the range of from 400 to 1100 daltons, more preferably in the range of from 400 to 800 daltons, more prefer-ably in the range of from 450 to 550 daltons.

Further in the case where the process further comprises (vi) and (vii) as defined hereinabove, it is preferred that X is O, and wherein the second end-capping agent according to (vi) exhibits a hydroxyl number in the range of from 5 to 200 mg(KOH)/g, more preferably in the range of from 15 to 175 mg(KOH)/g, more preferably in the range of from 45 to 145 mg(KOH)/g, more prefer-ably in the range of from 75 to 130 mg(KOH)/g, more preferably in the range of from 100 to 120 mg(KOH)/g, wherein the hydroxyl number is more preferably determined according to DIN 53240.

Further in the case where the process further comprises (vi) and (vii) as defined hereinabove, it is preferred that the second end-capping agent according to (vi) exhibits a viscosity in the range of from 5 to 200 mm²/s, more preferably in the range of from 15 to 175 mm²/s, more preferably in the range of from 45 to 145 mm²/s, more preferably in the range of from 75 to 130 mm²/s,

more preferably in the range of from 100 to 120 mm²/s, wherein the viscosity is preferably de-termined at a temperature in the range of from 15 to 25° C., more preferably at a temperature of 19 to 21° C., more preferably at a temperature of 20° C., wherein the viscosity is more preferably determined according to DIN 51562.

Further in the case where the process further comprises (vi) and (vii) as defined hereinabove, it is preferred that the second end-capping agent according to (vi) comprises in the range of from 0 to 1 weight-%, more preferably in the range of from 0 to 0.6 weight-%, more preferably in the range of from 0 to 0.55 weight-%, of water, based on the weight of the second end-capping agent, wherein the water content is more preferably determined according to EN 13267.

Further in the case where the process further comprises (vi) and (vii) as defined hereinabove, it is preferred that the mixture obtained in (vii) comprises an amount in the range of from 55 to 85 weight-%, more preferably in the range of from 60 to 80 weight-%, more preferably in the range of from 65 to 75 weight-%, of the second end-capping agent, based on the weight of the carbodiimide obtained in (ii) or (iv).

Further in the case where the process further comprises (vi) and (vii) as defined hereinabove, it is preferred that the gas atmosphere in (vii) comprises, more preferably consists of, an inert gas, wherein the gas atmosphere in (vii) more preferably comprises, more preferably consists of, one or more of nitrogen and argon.

Further in the case where the process further comprises (vi) and (vii) as defined hereinabove, it is preferred that the end-capping conditions according to (vii) comprise a temperature in the range of from 80 to 160° C., more preferably in the range of from 100 to 140° C., more preferably in the range of from 110 to 130° C.

Further in the case where the process further comprises (vi) and (vii) as defined hereinabove, it is preferred that the mixture obtained in (vi) is subjected to end-capping conditions according to (vii) for a duration in the range of from 1 to 10 h, more preferably in the range of from 3 to 7 h,

more preferably in the range of from 4 to 6 h.

Further in the case where the process further comprises (vi) and (vii) as defined hereinabove, it is preferred that the carbodiimide being end-capped obtained in (vii) comprises an amount of isocyanate groups, calculated as NCO, in the range of from 0 to 0.1 weight-%, more preferably in the range of from 0 to 0.01 weight-%, more preferably in the range of from 0 to 0.001 weight-%, based on the weight of the mixture obtained in (vii).

It is preferred that the process further comprises
(viii) isolating the carbodiimide from the mixture obtained in (ii), (iii), (iv), or (vii).

### Product-by-Process

Further, the present invention relates to a carbodiimide, preferably a carbodiimide having formu-la (I):

Q¹-[Q²-N═C═N]ₙ-Q³-Q⁴ (I)

wherein n is in the range of from 1 to 500, more preferably in the range of from 2 to 20, more preferably in the range of from 3 to 15, more preferably in the range of from 4 to 10, and wherein Q² and Q³ stands for an organic backbone and Q¹ and Q⁴ stands for an organic end group, as obtained and/or obtainable by the process according to any one of the embodiments disclosed herein.

### Use

Yet further, the present invention relates to a use of a carbodiimide according to any one of the embodiments disclosed herein as a stabilizer, more preferably as a hydrolysis stabilizer, for a polymer, more preferably for a thermoplastic polymer, more preferably for a thermoplastic poly-ester, more preferably for one or more of a polyurethane (PU), preferably a thermoplastic polyu-rethane (TPU), a polyurea, a polyethylene terephthalate (PET), a polybutylene terephthalate (PBT), a polyactide (PLA), a polyamide, a polyesteramide, a polycaprolactone, and a polyether-sulfone (PES).

By way of example, potassium dioxobis[glycolato(2−)]molybdate(VI) is considered according to the present invention as a catalytic compound comprising two double bonds, and sodium mo-lybdate (Na₂MoO₄) is considered as comprising two double bonds.

The carbodiimide preparation according to the inventive process can be carried out in the ab-sence or presence of solvents which are inert under the reaction conditions. It is preferred, however, that no solvent is used.

The carbodiimide groups of the carbodiimides and polycarbodiimides of the present invention are bound to non-aromatic carbon atoms. This offers the significant advantage that no aromatic amines are liberated on possible cleavage of the carbodiimides. The carbodiimides and poly-carbodiimides of the present invention are therefore of less toxicological concern.

In the context of the present invention, a tertiary monoisocyanate is a compound comprising one isocyanate group NCO, wherein said isocyanate group is connected to a tertiary carbon atom. Similarly, a primary monoisocyanate is a compound comprising one isocyanate group NCO, wherein said isocyanate group is connected to a primary carbon atom. Similarly, a sec-ondary monoisocyanate is a compound comprising one isocyanate group NCO, wherein said isocyanate group is connected to a secondary carbon atom.

Further, a tertiary diisocyanate is a compound comprising two isocyanate groups NCO, wherein each of said isocyanate groups is connected to a tertiary carbon atom. Similarly, a primary diisocyanate is a compound comprising two isocyanate groups NCO, wherein each of said iso-cyanate groups is connected to a primary carbon atom. Similarly, a secondary diisocyanate is a compound comprising two isocyanate groups NCO, wherein each of said isocyanate groups is connected to a secondary carbon atom.

Thus, in the context of the present invention, an isocyanate compound comprising two or more isocyanate groups NCO, wherein at least one of said isocyanate groups is connected to a pri-mary carbon atom or to a secondary carbon atom, is not considered as a tertiary diisocyanate.

In the context of the present invention, an alkyl group consists of carbon atoms and hydrogen atoms. Thus, an alkyl group according to the present invention does not comprise a further sub-stituent, e.g. a hydroxyl or chloride group, unless otherwise defined.

The present invention is further illustrated by the following set of embodiments and combina-tions of embodiments resulting from the dependencies and back-references as indicated. In particular, it is noted that in each instance where a range of embodiments is mentioned, for ex-ample in the context of a term such as “The process of any one of embodiments 1 to 4”, every embodiment in this range is meant to be explicitly disclosed for the skilled person, i.e. the word-ing of this term is to be understood by the skilled person as being synonymous to “The process of any one of embodiments 1, 2, 3, and 4”.

Further, it is explicitly noted that the following set of embodiments is not the set of claims deter-mining the extent of protection, but represents a suitably structured part of the description di-rected to general and preferred aspects of the present invention.
1. A process for preparing a carbodiimide, preferably for preparing a carbodiimide having formula (I):

Q¹-[Q²-N═C═N]ₙ-Q³-Q⁴ (I)
wherein n is in the range of from 1 to 500, preferably in the range of from 2 to 20, more preferably in the range of from 3 to 15, more preferably in the range of from 4 to 10, and wherein Q² and Q³ stands for an organic backbone and Q¹ and Q⁴ stands for an organic end group, the process comprising
(i) providing a mixture comprising one or more isocyanates and a catalytic compound; wherein the catalytic compound comprises a metal M and oxygen, wherein the metal M is one or more of Mo and W, and wherein at least a portion of the metal M comprised in the catalytic compound is bound to oxygen via one or more single bonds, via one or more double bonds, or via one or more single and double bonds;
(ii) subjecting the mixture obtained in (i) to reaction conditions in a gas atmosphere, wherein the reaction conditions comprise a temperature in the range of from 45 to 220° C.;
   and obtaining a mixture comprising the carbodiimide, preferably a mixture compris-ing the carbodiimide having formula (I).
2. The process of embodiment 1, wherein from 90 to 100 mol-%, preferably from 95 to 100 mol-%, more preferably from 99 to 100 mol-%, of the metal M comprised in the catalytic compound, calculated as elemental M, is bound to oxygen via one or more single bonds, via one or more double bonds, or via one or more single and double bonds.
3. The process of embodiment 1 or 2, wherein at least a portion of the metal M comprised in the catalytic compound is bound to oxygen via one or more double bonds, preferably via one or two double bonds, more preferably via two double bonds.
4. The process of any one of embodiments 1 to 3, wherein the metal M is in oxidation state +IV or +VI, preferably in oxidation state +VI.
5. The process of any one of embodiments 1 to 4, wherein the catalytic compound compris-es, preferably consists of, one or more salts
   wherein the one or more salts preferably comprise one or more of an anionic complex of one or more atoms of the metal M, a cationic complex of one or more atoms of the metal M, a cationic oxidic compound of one or more atoms of the metal M, and an anionic oxidic compound of one or more atoms of the metal M, more preferably one or more of an anion-ic complex of one or more atoms of the metal M and an anionic oxidic compound of one or more atoms of the metal M.
6. The process of any one of embodiments 1 to 5, wherein the catalytic compound compris-es a salt comprising a cation selected from the group consisting of ammonium (NH₄⁺), tri-methylammonium (NH(CH₃)₃⁺), anilinium (C₆H₅NH₃⁺), the diammonium ion of ethylenedi-amine (H₃NCH₂CH₂NH₃²⁺), tetrabutylammonium (Bu₄N⁺), Li⁺, Na⁺, K⁺, Mg²⁺, Ca²⁺, Sr²⁺, Ba²⁺, and a mixture of two or more thereof,
   preferably selected from the group consisting of Li⁺, Na⁺, K⁺, and a mixture of two or more thereof,
   wherein the catalytic compound more preferably comprises a salt comprising Li⁺.
7. The process of any one of embodiments 1 to 6, wherein the catalytic compound compris-es an anionic or cationic complex of one or more atoms of the metal M, and wherein the complex further comprises one or more, optionally substituted, ligands L, preferably one or two, optionally substituted, ligands L.
8. The process of embodiment 7, wherein the catalytic compound comprises a complex, preferably an anionic complex or a cationic complex, comprising a single atom of the metal M, wherein one or more ligands L independently from each other are coordinated to the single atom of the metal M,
   wherein the one or more ligands L independently from each other preferably comprise one or more of O and S, more preferably two O, or two S, or one O and one S, and
   wherein the one or more ligands L independently from each other more preferably are co-ordinated to the single atom of the metal M via one O, or one S, or two O, or two S, or one O and one S, preferably via two O or two S.
9. The process of embodiment 7, wherein the catalytic compound comprises a complex, preferably an anionic complex or a cationic complex, comprising two atoms of the metal M, wherein one or more ligands L independently from each other coordinate to two atoms of the metal M,
   wherein the one or more ligands L independently from each other preferably comprise one or more of O and S, preferably two O, or two S, or one O and one S, and wherein the one or more ligands L independently from each other preferably coordinate to the two atoms of the metal M via one O, or one S, or two O, or two S, or one O and one S, preferably via two O, wherein the one or more ligands L more preferably are a bridging ligand.
10. The process of any one of embodiments 7 to 9, wherein one or more ligands L independently from each other comprise a hydroxyl anion, wherein preferably one, two, or three of the one or more ligands L independently from each other are a hydroxyl anion.
11. The process of any one of embodiments 7 to 10, wherein one or more ligands L independently from each other are selected from the group consisting of 1,1-methanediolate, 1,1-thiomethanediolate, 1,1-dithiomethanediolate, formate, thioformate, dithioformate, 1,2-ethanediolate, 1,2-thioethanediolate, 1,2-dithioethanediolate, 1,3-propanediolate, 1,3-thiopropanediolate, 1,3-dithiopropanediolate, and a mixture of two or more thereof, preferably from the group consisting of 1,1-methanediolate, 1,1-thiomethanediolate, 1,1-dithiomethanediolate, formate, thioformate, dithioformate, 1,2-ethanediolate, 1,2-thioethanediolate, 1,2-dithioethanediolate, and a mixture of two or more thereof,
   more preferably from the group consisting of formate, thioformate, dithioformate, 1,2-ethanediolate, 1,2-thioethanediolate, 1,2-dithioethanediolate, and a mixture of two or more thereof,
   more preferably from the group consisting of formate, thioformate, dithioformate, 1,2-ethanediolate, 1,2-thioethanediolate, 1,2-dithioethanediolate, and a mixture of two or more thereof,
   wherein the one or more ligands L more preferably are one or more of dithioformate and 1,2-ethanediolate.
12. The process of embodiment 11, wherein the one or more ligands L are substituted with one or more substituents, preferably with one or two substituents.
13. The process of embodiment 12, wherein the one or more substituents are independently from each other selected from the group consisting of Oxo (═O), Thio (═S), hydroxyl, NR¹R², wherein R¹ and R² independently from each other are (C₁-C₆)alkyl, preferably methyl, ethyl, n-propyl, or n-butyl, more preferably methyl, optionally substituted (C₁-C₁₂)alkyl, optionally substituted cycloaliphatic (C₅-C₁₀)alkyl, optionally substituted (C₆-C₉)aryl, optionally substituted (C₇-C₁₅)aralkyl, and optionally substituted (C₇-C₁₅)alkaryl,
   more preferably selected from the group consisting of optionally substituted (C₁-C₅)alkyl, optionally substituted cycloaliphatic (C₅-C₆)alkyl, optionally substituted (C₆-C₉)aryl, optionally substituted (C₇-C₁₂)aralkyl, and optionally substituted (C₇-C₁₂)alkaryl,
   more preferably selected from the group consisting of optionally substituted (C₁-C₆)alkyl, optionally substituted cycloaliphatic (C₅-C₆)alkyl, optionally substituted (C₆)aryl, and optionally substituted (C₇-C₁₀)alkaryl,
   more preferably selected from the group consisting of optionally substituted (C₇-C₉)alkaryl,
   wherein the optionally substituted (C₁-C₁₂)alkyl, the optionally substituted cycloaliphatic (C₅-C₁₀)alkyl, the optionally substituted (C₆-C₉)aryl, the optionally substituted (C₇-C₁₅)aralkyl, and the optionally substituted (C₇-C₁₅)alkaryl, are preferably substituted with one or more of F, Cl, Br, I, OH, SH, and NR³R⁴, wherein R³ and R⁴ independently from each other are H, or (C₁-C₆)alkyl, preferably methyl, ethyl, n-propyl, or n-butyl, more preferably methyl,
   wherein one or more of the optionally substituted (C₁-C₁₂)alkyl, the optionally substituted cycloaliphatic (C₅-C₁₀)alkyl, the optionally substituted (C₆-C₉)aryl, the optionally substituted (C₇-C₁₅)aralkyl, and the optionally substituted (C₇-C₁₅)alkaryl, independently from each other are more preferably linear, branched, or cyclic, more preferably linear.
14. The process of any one of embodiments 7 to 10, wherein the catalytic compound comprises a complex, preferably an anionic complex or a cationic complex, comprising a single atom of the metal M, wherein one or more ligands L independently from each other are coordinated to the single atom of the metal M,
   wherein the one or more ligands L independently from each other preferably comprise a carboxylate,
   preferably a carboxylate of an amino acid, wherein the amino acid is preferably selected from the group consisting of alanine, arginine, asparagine, aspartic acid, cysteine, glutamine, glutamic acid, glycine, histidine, isoleucine, leucine, lysine, methionine, proline, phenylalanine, serine, threonine, tryptophan, tyrosine, valine.
15. The process of any one of embodiments 7 to 10, wherein the catalytic compound comprises a complex, preferably an anionic complex or a cationic complex, comprising two atoms of the metal M, wherein one or more ligands L independently from each other coordi-nate to two atoms of the metal M,
   wherein the one or more ligands L independently from each other preferably comprise a carboxylate,
   preferably a carboxylate of an amino acid, wherein the amino acid is preferably selected from the group consisting of alanine, arginine, asparagine, aspartic acid, cysteine, glutamine, glutamic acid, glycine, histidine, isoleucine, leucine, lysine, methionine, proline, phenylalanine, serine, threonine, tryptophan, tyrosine, valine.
16. The process of any one of embodiments 1 to 15, wherein the metal M is Mo.
17. The process of embodiment 16, wherein the catalytic compound comprises, preferably consists of, one or more of MoO₂ and MoO₃, wherein the catalytic compound preferably comprises, more preferably consists of, MoO₃.
18. The process of embodiment 16 or 17, wherein the catalytic compound comprises a salt comprising a molybdate anion, optionally a hydrated molybdate anion, preferably a mo-lybdate anion selected from the group consisting of MoO₄²⁻, Mo₂O₇²⁻, Mo₃O₁₀²⁻, Mo₄O₁₃²⁻, Mo₅O₁₆²⁻, Mo₆O₁₉²⁻, Mo₇O₂₄⁶⁻, Mo₈O₂₆⁴⁻, and a mixture of two or more thereof, wherein the catalytic compound preferably comprises MoO₄²⁻
19. The process of any one of embodiments 16 to 18, wherein the catalytic compound comprises, preferably consists of, one or more of Li₂MoO₄, Na₂MoO₄, and K₂MoO₄, preferably one or more of Li₂MoO₄ and K₂MoO₄, wherein the catalytic compound more preferably comprises, preferably consists of, Li₂MoO₄.
20. The process of any one of embodiments 16 to 19, wherein the catalytic compound comprises, preferably consists of, one or more of Li₂MoO₄, K₂MoO₄, Na₂MoO₄, bis(diethyldithiocarbamato)-dioxomolybdenum(VI), potassium dioxobis[glycolato(2-)]molybdate(VI), sodium dioxobis[methylglycolato(2−)]molybdate(VI), a dihydroxydi-μ-hydroxytetraoxodimolybdenum carboxylate, preferably dihydroxydi-μ-hydroxytetraoxodimolybdenum 2-(Dimethylamino)-3-phenylpropanoate or dihydroxydi-μ-hydroxytetraoxodimolybdenum 2-amino-3-phenylpropanoate.
21. The process of any one of embodiments 1 to 15, wherein the metal M is W.
22. The process of embodiment 21, wherein the catalytic compound comprises, preferably consists of, one or more of WO₂ and WO₃, wherein the catalytic compound preferably comprises, more preferably consists of, WO₃.
23. The process of embodiment 21 or 22, wherein the catalytic compound comprises a tung-state anion, optionally a hydrated tungstate anion, preferably a tungstate anion WO₄²⁻
24. The process of any one of embodiments 1 to 23, wherein from 95 to 100 weight-%, preferably from 99 to 100 weight-%, more preferably from 99.9 to 100 weight-%, of the catalytic compound consist of the metal M, O, optionally H, optionally C, optionally N, and optionally S, preferably of the metal M, O, H, C, and N.
25. The process of any one of embodiments 1 to 24, wherein the mixture obtained in (i) comprises an amount in the range of from 0 to 5 mol-%, preferably in the range of from 0 to 2.5 mol-%, more preferably in the range of from 0 to 2.0 mol-%, more preferably in the range of from 0 to 1.5 mol-%, more preferably in the range of from 0 to 1.0 mol-%, more preferably in the range of from 0 to 0.7 mol-%, more preferably in the range of from 0 to 0.5 mol-%, more preferably in the range of from 0 to 0.2 mol-%, more preferably in the range of from 0 to 0.1 mol-%, more preferably in the range of from 0 to 0.05 mol-%, more preferably in the range of from 0 to 0.02 mol-%, more preferably in the range of from 0 to 0.01 mol-%, of a phospholene oxide, calculated as molar amount of the phospholene ox-ide, preferably of a compound comprising a phosphorous oxygen double bond, calculated as molar amount of the compound comprising a phosphorous oxygen double bond, more preferably of a compound comprising P, calculated as molar amount of the compound comprising P, more preferably of P, calculated as elemental P, based on the amount of the one or more isocyanates, calculated as sum of the molar amounts of the one or more isocyanates, wherein the mixture obtained in (i) more preferably is essentially free of a phospholene oxide, preferably of a compound comprising a phosphorous oxygen double bond, more preferably of a compound comprising P, and more preferably of P.
26. The process of any one of embodiments 1 to 25, wherein the mixture obtained in (i) comprises an amount in the range of from 0 to 5 mol-%, preferably in the range of from 0 to 1.0 mol-%, more preferably in the range of from 0 to 0.1 mol-%, more preferably in the range of from 0 to 0.01 mol-%, of an alkali metal, calculated as elemental alkali metal, based on the amount of the one or more isocyanates, calculated as sum of the molar amounts of the one or more isocyanates, wherein the mixture obtained in (i) is more preferably essentially free of an alkali metal.
27. The process of any one of embodiments 1 to 26, wherein the mixture obtained in (i) comprises an amount in the range of from 0 to 5 mol-%, more preferably in the range of from 0 to 1.0 mol-%, more preferably in the range of from 0 to 0.1 mol-%, more preferably in the range of from 0 to 0.01 mol-%, of Mg, calculated as elemental Mg, preferably of one or more of Mg and Ca, calculated as elemental Mg and elemental Ca, respectively, more preferably of one or more of Mg, Ca, and Ba, calculated as elemental Mg, as elemental Ca and elemental Ba, respectively, more preferably of one or more of an alkali earth metal, calculated as elemental alkali earth metal, based on the amount of the one or more isocyanates, calculated as sum of the molar amounts of the one or more isocyanates, wherein the mixture obtained in (i) more preferably is essentially free of Mg, more preferably of one or more of Mg and Ca, more preferably of one or more of Mg, Ca, and Ba, more preferably of one or more of an alkali earth metal.
28. The process of any one of embodiments 1 to 27, wherein the one or more isocyanates comprised in the mixture according to (i) comprise, preferably consist of, one or more of a primary isocyanate, a secondary isocyanate and a tertiary isocyanate.
29. The process of any one of embodiments 1 to 28, wherein the one or more isocyanates comprised in the mixture according to (i) comprise, preferably consist of, one or more of a monoisocyanate and a diisocyanate.
30. The process of any one of embodiments 1 to 29, wherein the one or more isocyanates comprised in the mixture according to (i) comprise, preferably consist of, one or more of a primary monoisocyanate, a primary diisocyanate, a secondary monoisocyanate, a sec-ondary diisocyanate, a tertiary monoisocyanate, and a tertiary diisocyanate, wherein the one or more isocyanates preferably comprise, more preferably consist of, one or more of a secondary diisocyanate and a tertiary diisocyanate.
31. The process of any one of embodiments 1 to 30, wherein the one or more isocyanates comprised in the mixture according to (i) comprise, preferably consist of, an isocyanate,
   preferably a primary monoisocyanate, a secondary monoisocyanate or a tertiary monoiso-cyanate, having the formula (II):

OCN—C(R⁶,R⁷)—R⁸—C(R⁹,R¹⁰)—R¹¹ (II),
wherein R⁶ and R⁷ independently from one another are H or alkyl, wherein the alkyl is preferably linear or branched, more preferably linear,
wherein R⁶ and R⁷ independently from one another preferably are (C₁-C₂₂)alkyl, preferably (C₁-C₁₆)alkyl, more preferably (C₁-C₁₂)alkyl, more preferably (C₁-C₅)alkyl, more preferably (C₁-C₆)alkyl, more preferably (C₁-C₅)alkyl, more preferably (C₁-C₄)alkyl,
wherein R⁶ and R⁷ independently from one another more preferably are methyl, ethyl, propyl, isopropyl, n-butyl, sec-butyl, isobutyl, or tert-butyl, more preferably methyl,
wherein R⁹ and R¹⁰ independently from one another is H or alkyl, wherein the alkyl is preferably linear or branched, more preferably linear,
wherein R⁹ and R¹⁰ independently from one another preferably are H or (C₁-C₂₂)alkyl,
preferably (C₁-C₁₆)alkyl, more preferably (C₁-C₁₂)alkyl, more preferably (C₁-C₅)alkyl, more preferably (C₁-C₆)alkyl, more preferably (C₁-C₅)alkyl, more preferably (C₁-C₄)alkyl,
wherein R⁹ and R¹⁰ independently from one another more preferably are H, methyl, ethyl, propyl, isopropyl, n-butyl, sec-butyl, isobutyl, or tert-butyl, more preferably methyl,
wherein R⁸ is alkylene, alkarylene, aralkylene, or arylene, wherein the one or more of the alkylene, the alkarylene, the aralkylene, and the arylene is preferably linear, branched or cyclic,
wherein R⁸ is preferably selected from the group consisting of (C₁-C₁₆)alkylene, cycloali-phatic (C₅-C₂₀)alkylene, (C₆-C₁₅)arylene, (C₇-C₂₀)aralkylene, and (C₇-C₂₀)alkarylene, preferably selected from the group consisting of (C₁-C₅)alkylene, cycloaliphatic (C₅-C₁₀)alkylene, (C₆-C₉)arylene, (C₇-C₁₅)aralkylene, and (C₇-C₁₅)alkarylene, more preferably selected from the group consisting of (C₁-C₆)alkylene, (C₅-C₆)alkylene, (C₆)arylene, (C₇-C₁₂)aralkylene, and (C₇-C₁₂)alkarylene, more preferably selected from the group consist-ing of (C₃-C₆)alkylene, (C₇-C₁₀)aralkylene, and (C₇-C₁₀)alkarylene, more preferably select-ed from the group consisting of (C₇-C₉)aralkylene, and (C₇-C₉)alkarylene, wherein R⁸ is more preferably selected from the group consisting of (C₈-C₉)aralkylene, and (C₈-C₉)alkarylene,
wherein R⁸ is more preferably selected from the group consisting of methylene, ethylene, trimethylene, tetramethylene, pentamethylene, hexamethylene, ortho-phenylene, meta-phenylene, and para-phenylene,
wherein R⁸ is more preferably selected from the group consisting of pentamethylene, hex-amethylene, ortho-phenylene, meta-phenylene, and para-phenylene,
wherein R⁸ more preferably is para-phenylene,
wherein R¹¹ is selected from the group consisting of isopropenyl, NCNR¹², NHCONHR¹³, NHCONR¹⁴R¹⁵, and NHCOOR¹⁶,
wherein R¹² is one or more of (C₁-C₁₈)alkylene, (C₅-C₁₅)cycloalkylene, arylene, (C₇-C₁₈)alkarylene and (C₇-C₁₈)aralkylene, preferably one or more of (C₇-C₁₈)alkylarylene and (C₇-C₁₈)aralkylene,
wherein R¹³, R¹⁴, R¹⁵, and R¹⁶ independently from one another are selected from the group consisting of alkyl, cycloalkyl, alkaryl, aralkyl, a polyester group, a polyamide group, and —(CH₂)ₕ—O—[(CH₂)ₖ-0]_{g}-R¹⁷,
wherein h is in the range of from 1 to 3, k is in the range of from 1 to 3, g is in the range of from 0 to 12, and wherein R¹⁷ is H or (C₁-C₄)alkyl,
wherein R¹³, R¹⁴, R¹⁵, and R¹⁶ independently from one another are preferably selected from the group consisting of (C₁-C₁₂)alkyl, cycloaliphatic (C₅-C₁₀)alkyl, (C₆-C₉)aryl, (C₇-C₁₅)aralkyl, and (C₇-C₁₅)alkaryl, wherein one or more of the (C₁-C₁₂)alkyl, cycloaliphatic (C₅-C₁₀)alkyl, (C₆-C₉)aryl, (C₇-C₁₅)aralkyl, and (C₇-C₁₅)alkaryl independently from each other preferably are linear, branched, or cyclic, preferably linear,
more preferably selected from the group consisting of (C₁-C₈)alkyl, cycloaliphatic (C₅-C₆)alkyl, (C₆-C₉)aryl, (C₇-C₁₂)aralkyl, and (C₇-C₁₂)alkaryl,
more preferably selected from the group consisting of (C₁-C₆)alkyl, cycloaliphatic (C₅-C₆)alkyl, and (C₆)aryl,
more preferably selected from the group consisting of (C₁-C₅)alkyl,
more preferably selected from the group consisting of (C₁-C₄)alkyl,
wherein preferably R¹³, R¹⁴, R¹⁵, and R¹⁶ independently from one another are methyl, ethyl, propyl, isopropyl, n-butyl, sec-butyl, isobutyl, or tert-butyl.
32. The process of any one of embodiments 1 to 31, wherein the one or more isocyanates comprised in the mixture according to (i) comprises, preferably consists of, an isocyanate, preferably a tertiary diisocyanate, having the formula (III):

OCN—C(R¹⁸,R¹⁹)—R²⁰—C(R²¹,R²²)—NCO (III),
wherein R¹⁸, R¹⁹, R²¹ and R²² independently from one another are alkyl, wherein the alkyl preferably is linear or branched,
wherein R¹⁸, R¹⁹, R²¹ and R²² independently from one another preferably are (C₁-C₂₂)alkyl,
preferably (C₁-C₁₆)alkyl, more preferably (C₁-C₁₂)alkyl, more preferably (C₁-C₈)alkyl, more preferably (C₁-C₆)alkyl, more preferably (C₁-C₅)alkyl, more preferably (C₁-C₄)alkyl,
wherein R¹⁸, R¹⁹, R²¹ and R²² independently from one another more preferably are methyl, ethyl, propyl, isopropyl, n-butyl, sec-butyl, isobutyl, or tert-butyl, more preferably methyl,
wherein R²⁰ is alkylene, alkarylene, aralkylene, or arylene, wherein one or more of the al-kylene, the alkarylene, the aralkylene, and the arylene independently from each other are linear, branched or cyclic, preferably linear,
wherein R²⁰ is preferably selected from the group consisting of (C₁-C₁₅)alkylene, cycloali-phatic (C₈-C₂₀)alkylene, (C₆-C₁₈)arylene, (C₇-C₂₀)aralkylene, and (C₇-C₂₀)alkarylene, preferably selected from the group consisting of (C₁-C₈)alkylene, cycloaliphatic (C₅-C₁₀)alkylene, (C₆-C₉)arylene, (C₇-C₁₅)aralkylene, and (C₇-C₁₅)alkarylene, more preferably selected from the group consisting of (C₁-C₆)alkylene, (C₈-C₆)alkylene, (C₆)arylene, (C₇-C₁₂)aralkylene, and (C₇-C₁₂)alkarylene, more preferably selected from the group consist-ing of (C₃-C₆)alkylene, (C₇-C₁₀)aralkylene, and (C₇-C₁₀)alkarylene, more preferably select-ed from the group consisting of (C₇-C₉)aralkylene, and (C₇-C₉)alkarylene, wherein R²⁰ is
more preferably selected from the group consisting of (C₈-C₉)aralkylene, and (C₈-C₉)alkarylene,
wherein R²⁰ is more preferably selected from the group consisting of methylene, ethylene, trimethylene, tetramethylene, pentamethylene, hexamethylene, ortho-phenylene, meta-phenylene, and para-phenylene,
wherein R²⁰ more preferably is selected from the group consisting of pentamethylene, hexamethylene, ortho-phenylene, meta-phenylene, and para-phenylene,
wherein R²⁰ more preferably is para-phenylene.
33. The process of embodiment 32, wherein the one or more isocyanates comprised in the mixture according to (i) comprises, preferably consists of, a tertiary diisocyanate, preferably 1,3-bis(1-methyl-1-isocyanatoethyl)-benzene.
34. The process of any one of embodiments 1 to 33, wherein the one or more isocyanates comprised in the mixture according to (i) comprises from 10 to 44 weight-%, preferably from 15 to 40 weight-%, more preferably from 32 to 37 weight-%, of NCO, based on the amount of the one or more isocyanates, preferably of the amount of the one or more ter-tiary isocyanates, calculated as sum of the weights of the one or more isocyanates, preferably of the sum of the weights of the one or more tertiary isocyanates.
35. The process of any one of embodiments 1 to 34, wherein the one or more isocyanates comprised in the mixture according to (i) comprise, preferably consist of, an isocyanate, preferably a tertiary monoisocyanate, having the formula (IV):

OCN—C(R²⁵,R²⁶)—R²⁷—C(R²⁸,R²⁹)—R³⁰ (IV),
wherein R²⁵ and R²⁶ independently from one another is alkyl, wherein the alkyl is preferably linear or branched, more preferably linear,
wherein R²⁵ and R²⁶ independently from one another preferably is (C₁-C₂₂)alkyl, preferably (C₁-C₁₆)alkyl, more preferably (C₁-C₁₂)alkyl, more preferably (C₁-C₈)alkyl, more preferably (C₁-C₆)alkyl, more preferably (C₁-C₅)alkyl, more preferably (C₁-C₄)alkyl,
wherein R²⁵ and R²⁶ independently from one another more preferably are methyl, ethyl, propyl, isopropyl, n-butyl, sec-butyl, isobutyl, or tert-butyl, more preferably methyl,
wherein R²⁸ and R²⁹ independently from one another are H or alkyl, wherein the alkyl is preferably linear or branched, more preferably linear,
wherein R²⁸ and R²⁹ independently from one another preferably are H or, (C₁-C₂₂)alkyl,
preferably (C₁-C₁₆)alkyl, more preferably (C₁-C₁₂)alkyl, more preferably (C₁-C₈)alkyl, more preferably (C₁-C₆)alkyl, more preferably (C₁-C₅)alkyl, more preferably (C₁-C₄)alkyl,
wherein R²⁸ and R²⁹ independently from one another more preferably are H, methyl, ethyl, propyl, isopropyl, n-butyl, sec-butyl, isobutyl, or tert-butyl, more preferably methyl,
wherein R²⁷ is alkylene, alkarylene, aralkylene, or arylene, wherein one or more of the al-kylene, the alkarylene, the aralkylene, and the arylene independently from each other are branched or cyclic,
wherein R²⁷ is preferably selected from the group consisting of (C₁-C₁₆)alkylene, cycloali-phatic (C₈-C₂₀)alkylene, (C₆-C₁₅)arylene, (C₇-C₂₀)aralkylene, and (C₇-C₂₀)alkarylene, preferably selected from the group consisting of (C₁-C₅)alkylene, cycloaliphatic (C₅-C₁₀)alkylene, (C₆-C₉)arylene, (C₇-C₁₅)aralkylene, and (C₇-C₁₅)alkarylene, more preferably selected from the group consisting of (C₁-C₆)alkylene, (C₈-C₆)alkylene, (C₆)arylene, (C₇-C₁₂)aralkylene, and (C₇-C₁₂)alkarylene, more preferably selected from the group consist-ing of (C₃-C₆)alkylene, (C₇-C₁₀)aralkylene, and (C₇-C₁₀)alkarylene, more preferably select-ed from the group consisting of (C₇-C₉)aralkylene, and (C₇-C₉)alkarylene, wherein R²⁷ is
more preferably selected from the group consisting of (C₈-C₉)aralkylene, and (C₈-C₅)alkarylene,
wherein R²⁷ is more preferably selected from the group consisting of methylene, ethylene, trimethylene, tetramethylene, pentamethylene, hexamethylene, ortho-phenylene, meta-phenylene, and para-phenylene,
wherein R²⁷ more preferably is selected from the group consisting of pentamethylene, hexamethylene, ortho-phenylene, meta-phenylene, and para-phenylene,
wherein R²⁷ more preferably is para-phenylene,
wherein R³⁰ is selected from the group consisting of isopropenyl, NCNR³¹, NHCONHR³², NHCONR³³R³⁴, and NHCOOR³⁵,
wherein R³¹ is (C₁-C₁₈)alkylene, (C₅-C₁₅)cycloalkylene, arylene, (C₇-C₁₅)alkarylene or (C₇-C₁₈)aralkylene, preferably (C₇-C₁₈)alkylarylene or (C₇-C₁₈)aralkylene,
wherein R³², R³³, R³⁴, and R³⁵ independently from one another are selected from the group consisting of alkyl, cycloalkyl, alkaryl, aralkyl, a polyester group, a polyether group, a polyamide group, and —(CH₂)ₕ—O—[(CH₂)ₖ—O]_{g}—R³⁶,
wherein h is in the range of from 1 to 3, k is in the range of from 1 to 3, g is in the range of from 0 to 12, and wherein R³⁶ is H or (C₁-C₄)alkyl,
wherein R³², R³³, R³⁴, and R³⁵ independently from one another is preferably selected from the group consisting of (C₁-C₁₂)alkyl, cycloaliphatic (C₈-C₁₀)alkyl, (C₆-C₅)aryl, (C₇-C₁₅)aralkyl, and (C₇-C₁₅)alkaryl, wherein one or more of the (C₁-C₁₂)alkyl, cycloaliphatic (C₅-C₁₀)alkyl, (C₆-C₉)aryl, (C₇-C₁₅)aralkyl, and (C₇-C₁₅)alkaryl independently from each other are linear, branched, or cyclic, more preferably linear,
more preferably selected from the group consisting of (C₁-C₅)alkyl, cycloaliphatic (C₅-C₆)alkyl, (C₆-C₉)aryl, (C₇-C₁₂)aralkyl, and (C₇-C₁₂)alkaryl,
more preferably selected from the group consisting of (C₁-C₆)alkyl, cycloaliphatic (C₅-C₆)alkyl, and (C₆)aryl,
more preferably selected from the group consisting of (C₁-C₅)alkyl,
more preferably selected from the group consisting of (C₁-C₄)alkyl,
wherein preferably R³², R³³, R³⁴, and R³⁵ independently from one another are methyl, ethyl, propyl, isopropyl, n-butyl, sec-butyl, isobutyl, or tert-butyl.
36. The process of embodiment 35, wherein R³⁰ is NHCOOR³⁵, wherein R³⁵ is a polyether group, wherein R³⁵ is preferably O—(R⁴⁰—O)ₘ—R⁴¹,
   wherein R⁴⁰ is an alkylene group,
   wherein R⁴⁰ is preferably selected from the group consisting of methylene, ethylene, tri-methylene, tetramethylene, pentamethylene, hexamethylene, ortho-phenylene, meta-phenylene, para-phenylene,
   wherein R⁴⁰ more preferably is ethylene,
   wherein R⁴¹ is alkyl, wherein the alkyl is preferably linear or branched, more preferably linear,
   wherein R⁴¹ preferably is (C₁-C₂₂)alkyl, preferably (C₁-C₁₈)alkyl, more preferably partially unsaturated (C₁-C₁₈)alkyl, more preferably (C₁-C₁₆)alkyl, more preferably (C₁-C₁₂)alkyl,
   more preferably (C₁-C₅)alkyl, more preferably (C₁-C₆)alkyl, more preferably (C₁-C₅)alkyl,
   more preferably (C₁-C₄)alkyl,
   wherein R⁴¹ more preferably is methyl, ethyl, propyl, isopropyl, n-butyl, sec-butyl, isobutyl, or tert-butyl, more preferably methyl, and
   wherein m is an integer of 0 to 150, preferably an integer of 2 to 150, preferably an integer of 5 to 100, more preferably an integer of 7 to 50, more preferably an integer of 8 to 25,
   more preferably an integer of 9 to 20, more preferably an integer of 10 to 15.
37. The process of embodiment 36, wherein R⁴¹ is substituted alkyl, wherein the substituted alkyl preferably comprises one or more substituents, wherein the one or more substituents of the substituted alkyl independently from each other are preferably selected from the group consisting of (C₁-C₃)alkoxy, hydroxyl, amino, halides, and combinations of two or more thereof, more preferably from the group consisting of (C₁-C₂)alkoxy, hydroxyl, ami-no, chloro, bromo, fluoro, and combinations of two or more thereof, more preferably from the group consisting of hydroxyl, amino, chloro, and combinations thereof, wherein more preferably the one or more substituents independently from each other are hydroxyl, wherein the substituted alkyl preferably comprises one or more substituents, preferably one to four substituents, more preferably 1one to three substituents, more preferably one or two substituents, wherein the substituted alkyl more preferably comprises one substitu-ent.
38. The process of embodiment 36 or 37, wherein R⁴¹ is a partially unsaturated alkyl, wherein R⁴¹ preferably comprises one or more, more preferably from one to five, more preferably from one to three, more preferably one, C═C double bonds.
39. The process of any one of embodiments 36 to 38, wherein m=0,
   wherein R⁴¹ is alkyl, wherein the alkyl is preferably partially unsaturated, wherein the alkyl is preferably substituted,
   wherein R⁴¹ preferably is (C₁-C₂₂)alkyl, more preferably (C₁₂-C₂₂)alkyl, more preferably partially unsaturated (C₁₂-C₂₂)alkyl, more preferably partially unsaturated (C₁₆-C₂₀)alkyl,
   more preferably partially unsaturated (C₁₈-C₁₉)alkyl, wherein R⁴¹ preferably comprises one or more, more preferably from one to five, more preferably from one to three, more prefer-ably one, C═C double bonds, and wherein R⁴¹ more preferably is (2)-Octadec-9-en-yl (oleyl).
40. The process of any one of embodiments 1 to 39, wherein the one or more isocyanates comprises, preferably consists of, an aliphatic monoisocyanate or an aliphatic diisocya-nate,
   wherein the aliphatic monoisocyanate is preferably selected from the group consisting of (C₁-C₂₀)alkylene monoisocyanates, and a mixture of two or more thereof, more preferably from the group consisting of (C₃-C₁₈)alkylene monoisocyanates, and a mixture of two or more thereof, more preferably from the group consisting of (C₆-C₁₃)alkylene monoisocya-nates, and a mixture of two or more thereof,
   wherein the aliphatic diisocyanate is preferably selected from the group consisting of a (C₁-C₂₀)alkylene diisocyanates, and a mixture of two or more thereof, more preferably from the group consisting of (C₃-C₁₈)alkylene diisocyanates, and a mixture of two or more thereof, more preferably from the group consisting of (C₆-C₁₃)alkylene diisocyanates, and a mixture of two or more thereof,
   wherein the aliphatic diisocyanate is more preferably selected from the group consisting of 1,6-diisocyanatohexane (HDI), 1-isocyanato-4-[(4-isocyanatocyclohexyl)methyl]-cyclohexane (4,4′-diisocyanato dicyclohexylmethane; H₁₂MDI), 5-isocyanato-1-(isocyanatomethyl)-1,3,3-trimethylcyclohexane (isophorone diisocyanate; IPDI), and a mixture of two or more thereof,
   wherein the aliphatic diisocyanate more preferably is 1-isocyanato-4-[(4-isocyanatocyclohexyl)methyl]cyclohexane (4,4′-diisocyanato dicyclohexylmethane; H₁₂MDI).
41. The process of any one of embodiments 1 to 40, wherein the one or more isocyanates comprised in the mixture according to (i) comprise, preferably consist of, a tertiary monoi-socyanate, preferably 3-isopropenyl-alpha,alpha-dimethylbenzyl isocyanate (TMI).
42. The process of any one of embodiments 1 to 41, wherein the one or more isocyanates comprised in the mixture according to (i) comprise, preferably consist of, an aromatic iso-cyanate, preferably one or more of 1,3-diisopropyl-2-isocyanato benzene, 1,3,5-triisopropyl-2,4-diisocyanato benzene, and 1,3-Bis(2-isocyanatopropan-2-yl)benzene,
   more preferably 1,3-Bis(2-isocyanatopropan-2-yl)benzene.
43. The process of any one of embodiments 1 to 42, wherein Q¹ and Q⁴ independently from each other are —NCO or R¹¹ or R³⁰, and
   wherein Q² and Q³ independently from each other are —C(R⁶,R⁷)—R⁸—C(R⁹,R¹⁰)— or —C(R¹⁸,R¹⁹)—R²⁰—C(R²¹,R²²)— or —C(R²⁵,R²⁶)—R²⁷—C(R²⁸,R²⁹)—,
   wherein R⁶ and R⁷ are defined as in embodiment 31,
   wherein R⁸ is defined as in embodiment 31,
   wherein R⁹ and R¹⁰ are defined as in embodiment 31,
   wherein R¹¹ is defined as in embodiment 31,
   wherein R¹⁸ and R¹⁹ are defined as in embodiment 32,
   wherein R²⁰ is defined as in embodiment 32,
   wherein R²¹ and R²² are defined as in embodiment 32,
   wherein R²⁵ and R²⁶ are defined as in embodiment 35,
   wherein R²⁷ is defined as in embodiment 35,
   wherein R²⁸ and R²⁹ are defined as in embodiment 35,
   wherein R³⁰ is defined as in embodiment 35.
44. The process of any one of embodiments 1 to 43, wherein the reaction conditions in (ii) comprise a temperature in the range of from 50 to 220° C., preferably in the range of from 60 to 200° C., more preferably in the range of from 80 to 180° C., more preferably in the range of from 130 to 180° C., more preferably in the range of from 150 to 180° C.
45. The process of any one of embodiments 1 to 44, wherein the gas atmosphere in (ii) comprises, preferably consists of, an inert gas, wherein the gas atmosphere in (ii) preferably comprises, more preferably consists of, one or more of nitrogen and argon.
46. The process of any one of embodiments 1 to 45, wherein the reaction conditions in (ii) comprise a pressure in the range of from 1 to 1000 hPa(abs), preferably in the range of from 2 to 1000 hPa(abs), more preferably in the range of from 2.5 to 1000 hPa(abs).
47. The process of any one of embodiments 1 to 46, wherein the reaction conditions in (ii) comprise agitating the mixture obtained in (i), preferably stirring the mixture obtained in (i).
48. The process of any one of embodiments 1 to 47, wherein the mixture obtained in (i) is subjected to the reaction conditions in (ii) for a duration in the range of from 1 to 50 h, preferably in the range of from 1.5 to 40 h, more preferably in the range of from to 2 to 25 h.
49. The process of any one of embodiments 1 to 48, wherein the mixture according to (i) is provided in a reactor, wherein the reactor preferably comprises a reactor vessel or a tubular reactor.
50. The process of any one of embodiments 1 to 49, wherein the mixture provided in (i) further comprises a first end-capping agent, wherein the first end-capping agent has the formula (V):

HX—(R⁴⁴—Y)ₙ—R⁴⁵ (V),
wherein X is O, S, or NR⁴², wherein R⁴² is alkyl, wherein the alkyl is preferably linear or branched, more preferably linear, wherein X is preferably O,
wherein R⁴² is preferably (C₁-C₂₂)alkyl, more preferably (C₁-C₁₈)alkyl, more preferably par-tially unsaturated (C₁-C₁₈)alkyl, more preferably (C₁-C₁₆)alkyl, more preferably (C₁-C₁₂)alkyl, more preferably (C₁-C₈)alkyl, more preferably (C₁-C₆)alkyl, more preferably (C₁-C₅)alkyl, more preferably (C₁-C₄)alkyl,
wherein R⁴² more preferably is methyl, ethyl, propyl, isopropyl, n-butyl, sec-butyl, isobutyl, or tert-butyl, more preferably methyl,
wherein Y is O, S, or NR⁴³, wherein R⁴³ is alkyl, wherein the alkyl is preferably linear or branched, more preferably linear, wherein X is preferably O,
wherein R⁴³ is preferably (C₁-C₂₂)alkyl, more preferably (C₁-C₁₈)alkyl, more preferably par-tially unsaturated (C₁-C₁₈)alkyl, more preferably (C₁-C₁₆)alkyl, more preferably (C₁-C₁₂)alkyl, more preferably (C₁-C₈)alkyl, more preferably (C₁-C₆)alkyl, more preferably (C₁-C₅)alkyl, more preferably (C₁-C₄)alkyl,
wherein R⁴³ more preferably is methyl, ethyl, propyl, isopropyl, n-butyl, sec-butyl, isobutyl, or tert-butyl, more preferably methyl,
wherein R⁴⁴ is an alkylene group,
wherein R⁴⁴ is preferably selected from the group consisting of methylene, ethylene, tri-methylene, tetramethylene, pentamethylene, hexamethylene, ortho-phenylene, meta-phenylene, and para-phenylene,
wherein R⁴⁴ more preferably is ethylene,
wherein R⁴⁵ is alkyl, wherein the alkyl is preferably linear or branched, more preferably linear,
wherein R⁴⁵ is preferably (C₁-C₂₂)alkyl, more preferably (C₁-C₁₈)alkyl, more preferably par-tially unsaturated (C₁-C₁₈)alkyl, more preferably (C₁-C₁₆)alkyl, more preferably (C₁-C₁₂)alkyl, more preferably (C₁-C₈)alkyl, more preferably (C₁-C₆)alkyl, more preferably (C₁-C₅)alkyl, more preferably (C₁-C₄)alkyl,
wherein R⁴⁵ more preferably is methyl, ethyl, propyl, isopropyl, n-butyl, sec-butyl, isobutyl, or tert-butyl, more preferably methyl, and
wherein n is an integer of 0 to 150, preferably an integer of 2 to 150, preferably an integer of 5 to 100, more preferably an integer of 7 to 50, more preferably an integer of 8 to 25,
more preferably an integer of 9 to 20, more preferably an integer of 10 to 15,
wherein the first end-capping agent more preferably is a methylpolyethylene glycol.
51. The process of embodiment 50, wherein R⁴⁵ is substituted alkyl, wherein the substituted alkyl preferably comprises one or more substituents, wherein the one or more substituents of the substituted alkyl independently from each other are preferably selected from the group consisting of (C₁-C₃)alkoxy, hydroxyl, amino, halides, and combinations of two or more thereof, more preferably from the group consisting of (C₁-C₂)alkoxy, hydroxyl, ami-no, chloro, bromo, fluoro, and combinations of two or more thereof, more preferably from the group consisting of hydroxyl, amino, chloro, and combinations thereof, wherein more preferably the one or more substituents independently from each other are hydroxyl,
wherein the substituted alkyl group preferably comprises one or more substituents, preferably 1 to 4 substituents, more preferably 1 to 3 substituents, more preferably 1 or 2 sub-stituents, wherein the substituted alkyl group more preferably comprises 1 substituent.
52. The process of embodiment 50 or 51, wherein R⁴⁵ is partially unsaturated alkyl, wherein R⁴⁴ preferably comprises one or more, more preferably from one to five, more preferably from one to three, more preferably one, C═C double bonds.
53. The process of any one of embodiments 50 to 52, wherein n=0,
   wherein R⁴⁵ is alkyl, wherein the alkyl is preferably partially unsaturated, wherein the alkyl is preferably substituted,
   wherein R⁴⁵ more preferably is (C₁-C₂₂)alkyl, more preferably (C₁₂-C₂₂)alkyl, more preferably partially unsaturated (C₁₂-C₂₂)alkyl, more preferably partially unsaturated (C₁₆-C₂₀)alkyl, more preferably partially unsaturated (C₁₈-C₁₉)alkyl, wherein R⁴⁵ preferably comprises one or more, more preferably from one to five, more preferably from one to three, more preferably one, C═C double bonds, and wherein R⁴⁵ more preferably is (2)-Octadec-9-en-yl (oleyl).
54. The process of any one of embodiments 1 to 53, wherein the mixture provided in (i) further comprises a first end-capping agent, wherein the first end-capping agent has the formula (VI):

HX—R⁴⁷ (VI)
wherein X is O, S, or NR⁴⁶,
wherein R⁴⁶ and R⁴⁷ independently from each other is alkyl, wherein the alkyl is preferably linear or branched, more preferably linear, wherein X is preferably NR⁴⁶,
wherein R⁴⁶ and R⁴⁷ independently from each other preferably is (C₁-C₂₂)alkyl, more preferably (C₁-C₁₈)alkyl, more preferably partially unsaturated (C₁-C₁₈)alkyl, more preferably (C₁-C₁₆)alkyl, more preferably (C₁-C₁₂)alkyl, more preferably (C₁-C₅)alkyl, more preferably (C₁-C₆)alkyl, more preferably (C₁-C₅)alkyl, more preferably (C₁-C₄)alkyl,
wherein R⁴⁶ and R⁴⁷ independently from each other more preferably is methyl, ethyl, pro-pyl, isopropyl, n-butyl, sec-butyl, isobutyl, or tert-butyl, more preferably methyl.
55. The process of any one of embodiments 50 to 54, wherein the first end-capping agent has an average molecular mass in the range of from 100 to 5500 daltons, preferably in the range of from 200 to 3300 daltons, more preferably in the range of from 300 to 2200 daltons, more preferably in the range of from 400 to 1100 daltons, more preferably in the range of from 400 to 800 daltons, more preferably in the range of from 450 to 550 daltons.
56. The process of any one of embodiments 50 to 55, wherein X is O, and wherein the first end-capping agent exhibits a hydroxyl number in the range of from 5 to 200 mg(KOH)/g, preferably in the range of from 15 to 175 mg(KOH)/g, more preferably in the range of from 45 to 145 mg(KOH)/g, more preferably in the range of from 75 to 130 mg(KOH)/g, more preferably in the range of from 100 to 120 mg(KOH)/g, wherein the hydroxyl number is preferably determined according to DIN 53240.
57. The process of any one of embodiments 50 to 56, wherein the first end-capping agent exhibits viscosity in the range of from 5 to 200 mm²/s, preferably in the range of from 15 to 175 mm²/s, more preferably in the range of from 45 to 145 mm²/s, more preferably in the range of from 75 to 130 mm²/s, more preferably in the range of from 100 to 120 mm²/s, wherein the viscosity is preferably determined at a temperature in the range of from 15 to 25° C., more preferably at a temperature of 19 to 21° C., more preferably at a temperature of 20° C., wherein the viscosity is more preferably determined according to DIN 51562.
58. The process of any one of embodiments 50 to 57, wherein the first end-capping agent comprises an amount of water in the range of from 0 to 1 weight-%, preferably in the range of from 0 to 0.6 weight-%, more preferably in the range of from 0 to 0.55 weight-%, based on the weight of the first end-capping agent, wherein the water content is preferably determined according to EN 13267.
59. The process of any one of embodiments 1 to 58, wherein a molar ratio of the one or more isocyanates comprised in the mixture obtained in (i), calculated as sum of the molar amounts of the one or more isocyanates, to the catalytic compound comprised in the mixture obtained in (i), calculated as molar amount of the catalytic compound, in the mixture obtained in (i) is in the range of from 1:5 to 100:1, preferably in the range of from 1:3 to 75:1, more preferably in the range of from 1:2 to 50:1, more preferably in the range of from 1:1 to 10:1, more preferably in the range of from 2:1 to 8:1, more preferably in the range of from 4:1 to 7:1.
60. The process of any one of embodiments 1 to 59, wherein the mixture obtained in (i) comprises the catalytic compound in an amount in the range of from 0.1 to 100 mol-%, prefer-ably in the range of from 0.25 to 75 mol-%, more preferably in the range of from 0.5 to 50 mol-%, more preferably in the range of from 0.75 to 40 mol-%, more preferably in the range of from 1 to 36 mol-%, based on the amount of the one or more isocyanates com-prised in the mixture obtained in (i), calculated as sum of the molar amounts of the one or more isocyanates comprised in the mixture obtained in (i).
61. The process of any one of embodiments 1 to 60, wherein the mixture obtained in (i) comprises the catalytic compound in an amount in the range of from 1 to 35 weight-%, prefer-ably in the range of from 2 to 31 weight-%, more preferably in the range of from 3 to 30 weight-%, based on the amount of the one or more isocyanates comprised in the mixture obtained in (i), calculated as sum of the weights of the one or more isocyanates com-prised in the mixture obtained in (i).
62. The process of any one of embodiments 1 to 61, wherein the mixture obtained in (i) comprises an amount in the range of from 0 to 25 weight-%, preferably in the range of from 0.1 to 10 weight-%, more preferably in the range of from 1 to 5 weight-%, of xylene, preferably of an alkyl substituted benzene or an alkyl substituted dibenzene, wherein the alkyl comprises one or more of methyl, ethyl, and propyl, more preferably of a solvent, based on the weight of the mixture obtained in (i),
   wherein the mixture obtained in (i) is more preferably essentially free of xylene, more preferably of an alkyl substituted benzene or an alkyl substituted dibenzene, wherein the alkyl comprises one or more of methyl, ethyl, and propyl, more preferably of a solvent.
63. The process of any one of embodiments 1 to 62, wherein the mixture obtained in (i) comprises an amount in the range of from 0 to 5 weight-%, preferably in the range of from 0.1 to 1 weight-%, of a primary diisocyanate, preferably of a primary isocyanate, based on the weight of the mixture obtained in (i), wherein the mixture provided in (i) is more preferably essentially free of a primary diisocyanate, preferably of a primary isocyanate.
64. The process of any one of embodiments 1 to 63, wherein the mixture obtained in (ii) comprises a residual amount of the one or more isocyanates in the range of from 0 to 35 mol-%, preferably in the range of from 1 to 20 mol-%, more preferably in the range of from 5 to 15 mol-%, based on the amount of the one or more isocyanates comprised in the mixture obtained in (i), calculated as sum of the one or more isocyanates comprised in the mixture obtained in (i).
65. The process of any one of embodiments 1 to 64, wherein the process further comprises
   (iii) cooling the mixture obtained in (ii) to a temperature in the range of from 0 to less than 45° C., preferably in the range of from 10 to 25° C.
66. The process of any one of embodiments 1 to 65, wherein the process further comprises
   (iv) subjecting the mixture obtained in (ii) or (iii) to distillation conditions in a gas atmosphere, wherein the distillation conditions comprise a boiling point of the one or more isocyanates comprised in the mixture obtained in (i).
67. The process of embodiment 66, wherein the distillation conditions comprise a temperature in the range of from 170 to 210° C., preferably in the range of from 180 to 200° C.
68. The process of embodiment 66 or 67, wherein the distillation conditions comprise a pressure in the range of from 1 to 250 hPa(abs), preferably in the range of from 5 to 150 hPa(abs), more preferably in the range of from 5 to 10 hPa(abs).
69. The process of any one of embodiments 66 to 68, wherein the mixture obtained in (iv) comprises an amount of isocyanate groups, calculated as NCO, in the range of from 0 to
10.5 weight-%, preferably in the range of from 0 to 8.0 weight-%, based on the weight of the mixture obtained in (iv).
70. The process of any one of embodiments 66 to 69, wherein the process further comprises
   (v) recycling a portion of one or more isocyanates obtained in (iv) into (i).
71. The process of any one of embodiments 1 to 70, wherein the process further comprises
   (vi) mixing the carbodiimide obtained in (ii), (iii), or (iv) with a second end-capping agent;
   (vii) subjecting the mixture obtained in (vi) in a gas atmosphere to end-capping conditions, for obtaining a carbodiimide comprising one or more end-caps;
wherein the second end-capping agent according to (vi) preferably comprises one or more hydroxyl groups.
72. The process of embodiment 71, wherein the second end-capping agent according to (vi) has the formula (VII):

HX—(R⁵⁰—Y)ₙ—R⁵¹ (VII),
wherein X is O, S, or NR⁴⁸, wherein R⁴⁸ is alkyl, wherein the alkyl is preferably linear or branched, more preferably linear, wherein X is preferably O,
wherein R⁴⁸ is preferably (C₁-C₂₂)alkyl, more preferably (C₁-C₁₈)alkyl, more preferably par-tially unsaturated (C₁-C₁₈)alkyl, more preferably (C₁-C₁₆)alkyl, more preferably (C₁-C₁₂)alkyl, more preferably (C₁-C₈)alkyl, more preferably (C₁-C₆)alkyl, more preferably (C₁-C₅)alkyl, more preferably (C₁-C₄)alkyl,
wherein R⁴⁸ more preferably is methyl, ethyl, propyl, isopropyl, n-butyl, sec-butyl, isobutyl, or tert-butyl, more preferably methyl,
wherein Y is O, S, or NR⁴⁹, wherein R⁴⁹ is alkyl, wherein the alkyl is preferably linear or branched, more preferably linear, wherein X is preferably O,
wherein R⁴⁹ is preferably (C₁-C₂₂)alkyl, more preferably (C₁-C₁₈)alkyl, more preferably par-tially unsaturated (C₁-C₁₈)alkyl, more preferably (C₁-C₁₆)alkyl, more preferably (C₁-C₁₂)alkyl, more preferably (C₁-C₈)alkyl, more preferably (C₁-C₆)alkyl, more preferably (C₁-C₅)alkyl, more preferably (C₁-C₄)alkyl,
wherein R⁴⁹ more preferably is methyl, ethyl, propyl, isopropyl, n-butyl, sec-butyl, isobutyl, or tert-butyl, more preferably methyl,
wherein R⁵⁰ is an alkylene group,
wherein R⁵⁰ is preferably selected from the group consisting of methylene, ethylene, tri-methylene, tetramethylene, pentamethylene, hexamethylene, ortho-phenylene, meta-phenylene, and para-phenylene,
wherein R⁵⁰ more preferably is ethylene,
wherein R⁵¹ is alkyl, wherein the alkyl is preferably partially unsaturated, wherein the alkyl is preferably substituted,
wherein R⁵¹ preferably is alkyl, wherein the alkyl is preferably linear or branched, more preferably linear,
wherein R⁵¹ more preferably is (C₁-C₂₂)alkyl, more preferably (C₁-C₁₈)alkyl, more preferably partially unsaturated (C₁-C₁₈)alkyl, more preferably (C₁-C₁₆)alkyl, more preferably (C₁-C₁₂)alkyl, more preferably (C₁-C₈)alkyl, more preferably (C₁-C₆)alkyl, more preferably (C₁-C₅)alkyl, more preferably (C₁-C₄)alkyl,
wherein R⁵¹ more preferably is methyl, ethyl, propyl, isopropyl, n-butyl, sec-butyl, isobutyl, or tert-butyl, more preferably methyl, and
wherein n is an integer of 0 to 150, preferably an integer of 2 to 150, preferably an integer of 5 to 100, more preferably an integer of 7 to 50, more preferably an integer of 8 to 25,
more preferably an integer of 9 to 20, more preferably an integer of 10 to 15,
wherein the second end-capping agent according to (vi) more preferably is a methylpolyethylene glycol.
73. The process of embodiment 72, wherein R⁵¹ is substituted alkyl, wherein the substituted alkyl preferably comprises one or more substituents, wherein the one or more substituents of the substituted alkyl independently from each other are preferably selected from the group consisting of (C₁-C₃)alkoxy, hydroxyl, amino, halides, and combinations of two or more thereof, more preferably from the group consisting of (C₁-C₂)alkoxy, hydroxyl, ami-no, chloro, bromo, fluoro, and combinations of two or more thereof, more preferably from the group consisting of hydroxyl, amino, chloro, and combinations thereof, wherein more preferably the one or more substituents independently from each other are hydroxyl, wherein the substituted alkyl preferably comprises one or more substituents, preferably one to four substituents, more preferably one to three substituents, more preferably one or two substituents, wherein the substituted alkyl group more preferably comprises one sub-stituent.
74. The process of embodiment 72 or 73, wherein R⁵¹ is partially unsaturated alkyl, wherein R⁵¹ preferably comprises one or more, more preferably from one to five, more preferably from one to three, more preferably one, C═C double bonds.
75. The process of any one of embodiments 72 to 74, wherein n=0,
   wherein R⁵¹ is alkyl, wherein the alkyl is preferably partially unsaturated, wherein the alkyl is preferably substituted,
   wherein R⁵¹ is preferably (C₁-C₂₂)alkyl, more preferably (C₁₂-C₂₂)alkyl, more preferably partially unsaturated (C₁₂-C₂₂)alkyl, more preferably partially unsaturated (C₁₆-C₂₀)alkyl,
   more preferably partially unsaturated (C₁₈-C₁₉)alkyl, wherein R⁵¹ preferably comprises one or more, more preferably from one to five, more preferably from one to three, more prefer-ably one, C═C double bonds, and wherein R⁵¹ more preferably is (2)-Octadec-9-en-yl (oleyl).
76. The process of any one of embodiments 72 to 75, wherein the mixture provided in (i) further comprises a first end-capping agent, wherein the first end-capping agent has the formula (VIII):

HX—R⁵³ (VIII)
wherein X is O, S, or NR⁵²,
wherein R⁵² and R⁵³ independently from each other is alkyl, wherein the alkyl is preferably linear or branched, more preferably linear, wherein X is preferably NR⁵², wherein R⁵² and R⁵³ independently from each other preferably is (C₁-C₂₂)alkyl, more preferably (C₁-C₁₈)alkyl, more preferably partially unsaturated (C₁-C₁₈)alkyl, more preferably (C₁-C₁₆)alkyl, more preferably (C₁-C₁₂)alkyl, more preferably (C₁-C₅)alkyl, more preferably (C₁-C₆)alkyl, more preferably (C₁-C₅)alkyl, more preferably (C₁-C₄)alkyl,
   wherein R⁵² and R⁵³ independently from each other more preferably is methyl, ethyl, pro-pyl, isopropyl, n-butyl, sec-butyl, isobutyl, or tert-butyl, more preferably methyl.
77. The process of any one of embodiments 71 to 76, wherein the second end-capping agent according to (vi) has an average molecular mass in the range of from 100 to 5500 daltons,
   preferably in the range of from 200 to 3300 daltons, more preferably in the range of from 300 to 2200 daltons, more preferably in the range of from 400 to 1100 daltons, more preferably in the range of from 400 to 800 daltons, more preferably in the range of from 450 to 550 daltons.
78. The process of any one of embodiments 71 to 77, wherein X is O, and wherein the second end-capping agent according to (vi) exhibits a hydroxyl number in the range of from 5 to 200 mg(KOH)/g, preferably in the range of from 15 to 175 mg(KOH)/g, more preferably in the range of from 45 to 145 mg(KOH)/g, more preferably in the range of from 75 to 130 mg(KOH)/g, more preferably in the range of from 100 to 120 mg(KOH)/g, wherein the hy-droxyl number is preferably determined according to DIN 53240.
79. The process of any one of embodiments 71 to 78, wherein the second end-capping agent according to (vi) exhibits a viscosity in the range of from 5 to 200 mm²/s, preferably in the range of from 15 to 175 mm²/s, more preferably in the range of from 45 to 145 mm²/s,
   more preferably in the range of from 75 to 130 mm²/s, more preferably in the range of from 100 to 120 mm²/s, wherein the viscosity is preferably determined at a temperature in the range of from 15 to 25° C., more preferably at a temperature of 19 to 21° C., more preferably at a temperature of 20° C., wherein the viscosity is more preferably determined according to DIN 51562.
80. The process of any one of embodiments 71 to 79, wherein the second end-capping agent according to (vi) comprises in the range of from 0 to 1 weight-%, preferably in the range of from 0 to 0.6 weight-%, more preferably in the range of from 0 to 0.55 weight-%, of water, based on the weight of the second end-capping agent, wherein the water content is preferably determined according to EN 13267.
81. The process of any one of embodiments 71 to 80, wherein the mixture obtained in (vii) comprises an amount in the range of from 55 to 85 weight-%, preferably in the range of from 60 to 80 weight-%, more preferably in the range of from 65 to 75 weight-%, of the second end-capping agent, based on the weight of the carbodiimide obtained in (ii) or (iv).
82. The process of any one of embodiments 71 to 81, wherein the gas atmosphere in (vii) comprises, preferably consists of, an inert gas, wherein the gas atmosphere in (vii) prefer-ably comprises, more preferably consists of, one or more of nitrogen and argon.
83. The process of any one of embodiments 71 to 82, wherein the end-capping conditions according to (vii) comprise a temperature in the range of from 80 to 160° C., preferably in the range of from 100 to 140° C., more preferably in the range of from 110 to 130° C.
84. The process of any one of embodiments 71 to 83, wherein the mixture obtained in (vi) is subjected to end-capping conditions according to (vii) for a duration in the range of from 1 to 10 h, preferably in the range of from 3 to 7 h, more preferably in the range of from 4 to 6 h.
85. The process of any one of embodiments 71 to 84, wherein the carbodiimide being end-capped obtained in (vii) comprises an amount of isocyanate groups, calculated as NCO, in the range of from 0 to 0.1 weight-%, preferably in the range of from 0 to 0.01 weight-%,
   more preferably in the range of from 0 to 0.001 weight-%, based on the weight of the mixture obtained in (vii).
86. The process of any one of embodiments 1 to 85, wherein the process further comprises
   (viii) isolating the carbodiimide from the mixture obtained in (ii), (iii), (iv), or (vii).
87. A carbodiimide, preferably a carbodiimide having formula (I):

Q¹-[Q²-N═C═N]ₙ-Q³-Q⁴ (I)
wherein n is in the range of from 1 to 500, preferably in the range of from 2 to 20, more preferably in the range of from 3 to 15, more preferably in the range of from 4 to 10, and
   wherein Q² and Q³ stands for an organic backbone and Q¹ and Q⁴ stands for an organic end group, as obtained and/or obtainable by the process according to any one of embodiments 1 to 86.
88. Use of a carbodiimide according to embodiment 87 as a stabilizer, preferably as a hydrolysis stabilizer, for a polymer, more preferably for a thermoplastic polymer, more preferably for a thermoplastic polyester, more preferably for one or more of a polyurethane (PU),
   preferably a thermoplastic polyurethane (TPU), a polyurea, a polyethylene terephthalate (PET), a polybutylene terephthalate (PBT), a polyactide (PLA), a polyamide, a polyesteramide, a polycaprolactone, and a polyethersulfone (PES).

The present invention is further illustrated by the following reference examples, examples, and comparative examples.

### EXAMPLES

### Reference Example 1: Determination of FTIR Spectra and ATR-FTIR Spectra

FTIR spectra, in particular for determination of characteristic bands for isocyanate groups, were recorded via single reflection ATR module on an Eco-ATR from Brücker. A sample was added directly onto the ATR crystal without any modification. Typically, it is expected that an isocyanate group NCO shows a band at about 2200 cm⁻¹ in the FTIR spectrum and that a carbodiimide group shows a band at about 2100 cm-1.

### Reference Example 2: Preparation of a Prepolymer

100.0 g tetramethylxylene diisocyanate (TMXDI), 100.0 g 4,4′-diisocyanato dicyclohexylmethane (H₁₂MDI; Evonik) and 60.0 g methylpolyethylene glycol (Pluriol A500E; BASF SE; having an average weight of 500 g/mol) were charged into a 500 mL, 4-neck round bottom flask equipped with a thermometer (coupled with a temperature regulated oil-bath), mechanical stirring, a cold-water condenser and nitrogen inlet. The mixture was stirred and heated at a temperature of 120° C. After approximately 9 hours the NCO content, determined via infrared-spectroscopy, reached a value of 7.6% corresponding to full conversion of the alcohol into urethane.

### Reference Example 3: Preparation of dihydroxydi-μ-hydroxytetraoxodimolybdenum 2-(dimethylamino)-3-phenylpropanoate

Sodium molybdate (2.5 g, 12 mmol) were dissolved in water (40 ml, degassed). Then, N,N-Dimethyl-L-phenylalanine (1.17 g, 6 mmol) was added thereto. Via a dropping funnel, 25.5 ml of 1 M aqueous nitric acid (HNO₃) was slowly added. During the addition of aqueous nitric acid the pH-value decreased from 6.8 to 1.8 and a white suspension is formed. The suspension was stirred for 1.5 h at room temperature. Then, the white solid was filtered off and washed with ace-tone and diethyl ether (each 2×10 ml). The white solid was dried under vacuum.

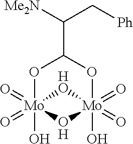

Molecular structure of dihydroxydi-μ-hydroxytetraoxodimolybdenum 2-(dimethylamino)-3-phenylpropanoate.

### Reference Example 4: Preparation of dihydroxydi-μ-hydroxytetraoxodimolybdenum 2-amino-3-phenylpropanoate

Reference Example 3 was repeated whereby L-phenylalanine was used as starting material instead of N,N-Dimethyl-L-phenylalanine.

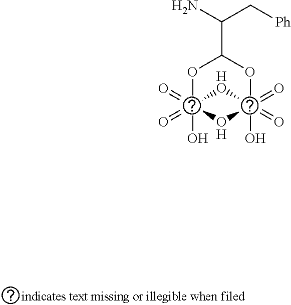

Molecular structure of dihydroxydi-μ-hydroxytetraoxodimolybdenum 2-amino-3-phenylpropanoate.

### Reference Example 5: Bis(N,N-diethyldithiocarbamato)dioxomolybdenum(VI)

Bis(N,N-diethyldithiocarbamato)dioxomolybdenum(VI) (CAS 19680-83-2) was purchased from Sigma Aldrich.

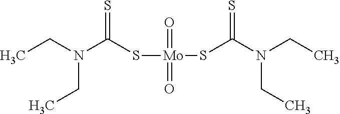

Molecular structure of bis(N,N-diethyldithiocarbamato)dioxomolybdenum(VI).

### Reference Example 6: Preparation of potassium dioxobis[glycolato(2−)]molybdate(VI)

Potassium dioxobis[glycolato(2−)]molybdate(VI) was synthezised according to a known proce-dure disclosed in “Physicochemical studies on the reactions of Na tungstate and Na molybdate with glycolic acid” by Banerjee, S. P.; Bhattacharya, Arun K in Proceedings of the Institution of Chemists (India) 1963, vol. 35, issue 5, pages 247-250.

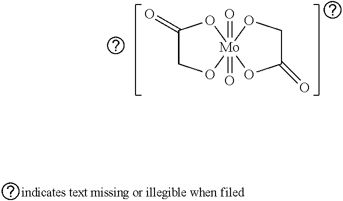

Molecular structure of potassium dioxobis[glycolato(2−)]molybdate(VI).

### Reference Example 7: Preparation of sodium dioxobis[methylglycolato(2−)]molybdate(VI)

Sodium dioxobis[methylglycolato(2−)]molybdate(VI) was synthezised according to a known pro-cedure disclosed in “Physicochemical studies on the reactions of Na tungstate and Na molybdate with glycolic acid” by Banerjee, S. P.; Bhattacharya, Arun K.

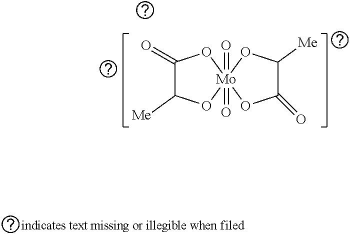

Molecular structure of Sodium dioxobis[methylglycolato(2−)]molybdate(VI)

### Example 1: Preparation of a polycarbodiimide

100.0 g tetramethylxylene diisocyanate (0.41 mol; TMXDI) and 3.0 g of the Mo-containing catalytic compound according to Reference example 3 were charged to a 250 ml, 4-neck round bottom flask equipped with a thermometer (coupled with a temperature regulated oil-bath), mechanical stirring, a cold-water condenser and nitrogen inlet. The mixture was stirred and heated at 175° C. After approximately 4 hours the NCO content reached a value of 13.8%. FTIR showed a strong band at 2100 cm⁻¹ characteristic of the formation of a carbodiimide. The inte-gration of the band showed that more than 90 mol-% of the isocyanate groups were converted into carbodiimide. The mixture was then distillated for 2 hours (using a distillation bridge) at 190° C. and 100 mbar. The corresponding product had an NCO content of 5.0%. Subsequently, 54.0 g methylpolyethylene glycol (Pluriol A500E; BASF SE; having an average weight of 500 g/mol) were added. After 5 hours at 120° C., the NCO content, determined via infrared-spectroscopy, reached 0.0%. Then, the mixture was cooled down to room temperature. The resulting polycarbodiimide showed an NCN content of 5 weight-%.

### Examples 2 to 10 and Comparative Examples 11 to 13: Preparation of a polycarbodiimide

Preparation of a polycarbodiimide was performed using the catalytic compounds noted in Table 1 below. For each example, 10 g of tetramethylxylene diisocyanate (TMXDI) were mixed with 3 g of the respective catalytic compound in a 50 ml vial sealed with a teflon-equipped cap. The vial was placed in the block reactor, stirred using a magnetic stirrer and heated up to 180° C. After the respective reaction time, the mixture was analyzed by Infrared spectroscopy (ATR-FTIR) which revealed the presence of carbodiimide groups via the appearance of the typical NCN band around 2100 cm-1. Further, NCO content and selectivity towards the formation of carbodiimide groups were measured.

TABLE 1
Compositions and conditions for the preparation of a polycarbodiimide
according to Examples 2-10 and Comparative Examples 11-13, as
well as the NCO content of the respective mixture and the selectivity
towards the formation of carbodiimide groups.

| | | | | NCO | |
|---|---|---|---|---|---|
| | | | Reaction | content | Selectivity |
| # | Catalytic compound | Isocyanate(s) | time [h] | [%] | [%] |
| Ex. 2 | Dihydroxydi-μ-hydroxytetra- | TMXDI | 16 | 28.0 | 80 |
| | oxodimolybdenum 2-amino-3- | | | | |
| | phenylpropanoate | | | | |
| Ex. 3 | Lithium molybdate, Li₂MoO₄ | TMXDI | 11 | 30.9 | 33 |
| | (Sigma Aldrich) | | | | |
| Ex. 4 | Potassium molybdate, K₂MoO₄ | TMXDI | 11 | 29.7 | 32 |
| | (Sigma Aldrich) | | | | |
| Ex. 5 | Sodium molybdate, Na₂MoO₄ | TMXDI | 11 | 28.8 | 28 |
| | (Sigma Aldrich) | | | | |
| Ex. 6 | Bis(N,N-diethyldithio- | TMXDI | 6 | 28.9 | 62 |
| | carbamato)-dioxo- | | | | |
| | molybdenum(VI) (Sigma Al- | | | | |
| | drich) | | | | |
| Ex. 7 | Potassium dioxo- | TMXDI | 11 | 29.2 | 46 |
| | bis[glycolato(2-)]molybdate(VI) | | | | |
| Ex. 8 | Sodium dioxo- | TMXDI | 11 | 29.1 | 40 |
| | bis[methylglycolato(2-)]- | | | | |
| | molybdate(VI) | | | | |
| Ex. 9 | Dihydroxydi-μ-hydroxytetra- | H12MDI | 4.5 | 26.1 | 53 |
| | oxodimolybdenum 2-(dimethyl- | | | | |
| | amino)-3-phenylpropanoate | | | | |
| Ex. 10 | Dihydroxydi-μ-hydroxytetra- | Prepolymer | 8 | 1.2 | >90 |
| | oxodimolybdenum 2-(dimethyl- | according to | | | |
| | amino)-3-phenylpropanoate | Ref. Ex. 2 | | | |
| Comp. | Molybdenum carbide (Sigma | TMXDI | 10 | 31.1 | <5 |
| Ex. 11 | Aldrich) | | | | |
| Comp. | Sodiumorthovanadate, | TMXDI | 10 | 31.3 | <5 |
| Ex. 12 | Na₃VO₄ (Alfa Aeser) | | | | |
| Comp. | Potassium permanganate, | TMXDI | 10 | 18.3 | <5 |
| Ex. 13 | KMnO₄ (Sigma Aldrich) | | | | |

As can be gathered from the results shown in Table 1, the process according to the present invention successfully resulted in the formation of a polycarbodiimide, wherein in particular a specific catalytic compound was used. In particular, it can be seen from the results shown in Table 1 that the selectivity towards the formation of carbodiimide groups was at least 28% for all of Examples 2-10. Thus, according to the process of Examples 2-10 a comparatively high selectivity towards the formation of carbodiimide groups can be achieved. In contrast thereto, the process of Comparative Examples 11-13 achieved a selectivity towards the formation of carbodiimide groups of below 5% showing that a catalytic compound which does not comprise in particular a Mo—O bond or a Mo═O bond achieves a lower selectivity.

### CITED LITERATURE

U.S. Pat. No. 3,406,197 A
Banerjee, S. P.; Bhattacharya, Arun K: “Physicochemical studies on the reactions of Na tungstate and Na molybdate with glycolic acid” in Proceedings of the Institution of Chemists (India) 1963, vol. 35, issue 5, pages 247-250
JP S54 66656 A
DE 198 14 169 A1
U.S. Pat. No. 3,632,620 A

1-15. (canceled)

16. A process for preparing a carbodiimide, the process comprising:
(i) providing a mixture comprising one or more isocyanates and a catalytic compound; wherein the catalytic compound comprises a metal M and oxygen, wherein the metal M is Mo, and wherein at least a portion of the metal M comprised in the catalytic compound is bound to oxygen via one or more single bonds, via one or more double bonds, or via one or more single and double bonds;
wherein the catalytic compound is selected from the group consisting of Li₂MoO₄, Na₂MoO₄, K₂MoO₄, and an anionic or cationic complex of one or more atoms of the metal M, and wherein the complex further comprises one or more, optionally substituted, ligands L, wherein one or more ligands L independently from each other are selected from the group consisting of 1,1-methanediolate, 1,1-thiomethanediolate, 1,1-dithiomethanediolate, formate, thioformate, dithioformate, 1,2-ethanediolate, 1,2-thioethanediolate, 1,2-dithioethanediolate, 1,3-propanediolate, 1,3-thiopropanediolate, 1,3-dithiopropanediolate, and a mixture of two or more thereof;
(ii) subjecting the mixture obtained in (i) to reaction conditions in a gas atmosphere, wherein the reaction conditions comprise a temperature in the range of from 130 to 180° C.; and obtaining a mixture comprising the carbodiimide.

17. The process of claim 16, wherein the catalytic compound comprises a complex comprising a single atom of the metal M, wherein one or more ligands L independently from each other are coordinated to the single atom of the metal M.

18. The process of claim 16, wherein the catalytic compound comprises a complex comprising two atoms of the metal M, wherein one or more ligands L independently from each other coordinate to two atoms of the metal M.

19. The process of claim 16, wherein the catalytic compound comprises one or more of bis(diethyldithiocarbamato)-dioxomolybdenum(VI), potassium dioxobis[glycolato(2-)]molybdate(VI), sodium dioxobis[methylglycolato(2−)]molybdate(VI), and a dihydroxydi-μ-hydroxytetraoxodimolybdemum carboxylate.

20. The process of claim 16, wherein the mixture obtained in (i) comprises an amount in the range of from 0 to 5 mol-% of a phospholene oxide, calculated as molar amount of the phospholene oxide, based on the amount of the one or more isocyanates, calculated as sum of the molar amounts of the one or more isocyanates.

21. The process of claim 16, wherein the one or more isocyanates comprised in the mixture according to (i) comprise an isocyanate having the formula (II):
OCN—C(R⁶,R⁷)—R⁸—C(R⁹,R¹⁰)—R¹¹ (II),
wherein R⁶ and R⁷ independently from one another are H or alkyl,
wherein R⁹ and R¹⁰ independently from one another is H or alkyl,
wherein R⁸ is alkylene, alkarylene, aralkylene, or arylene,
wherein R¹¹ is selected from the group consisting of isopropenyl, NCNR¹², NHCONHR¹³, NHCONR¹⁴R¹⁵, and NHCOOR¹⁶,
wherein R¹² is one or more of (C₁-C₁₈)alkylene, (C₅-C₁₈)cycloalkylene, arylene, (C₇-C₁₈)alkarylene and (C₇-C₁₈)aralkylene,
wherein R¹³, R¹⁴, R¹⁵, and R¹⁶ independently from one another are selected from the group consisting of alkyl, cycloalkyl, alkaryl, aralkyl, a polyester group, a polyamide group, and —(CH₂)ₕ—O—[(CH₂)ₖ—O]₈—R¹⁷,
wherein h is in the range of from 1 to 3, k is in the range of from 1 to 3, g is in the range of from 0 to 12, and wherein R¹⁷ is H or (C₁-C₄)alkyl.

22. The process of claim 16, wherein the one or more isocyanates comprised in the mixture according to (i) comprises an isocyanate having the formula (III):
OCN—C(R¹⁸,R¹⁹)—R²⁰—C(R²¹,R²²)—NCO (III),
wherein R¹⁸, R¹⁹, R²¹ and R²² independently from one another are alkyl,
wherein R²⁰ is alkylene, alkarylene, aralkylene, or arylene, wherein one or more of the alkylene, the alkarylene, the aralkylene, and the arylene independently from each other are linear, branched or cyclic.

23. The process of claim 16, wherein the one or more isocyanates comprised in the mixture according to (i) comprises one or more of 1,3-bis(1-methyl-1-isocyanatoethyl)-benzene, 1,6-diisocyanatohexane (HDI), 1-isocyanato-4-[(4-isocyanatocyclohexyl)methyl]-cyclohexane (4,4′-diisocyanato dicyclohexylmethane; H₁₂MDI), 5-isocyanato-1-(isocyanatomethyl)-1,3,3-trimethylcyclohexane (isophorone diisocyanate; IPDI), 3-isopropenyl-alpha,alpha-dimethylbenzyl isocyanate (TMI), 1,3-diisopropyl-2-isocyanato benzene, 1,3,5-triisopropyl-2,4-diisocyanato benzene, and 1,3-bis(2-isocyanatopropan-2-yl)benzene (TMXDI).

24. The process of claim 16, wherein a molar ratio of the one or more isocyanates comprised in the mixture obtained in (i), calculated as sum of the molar amounts of the one or more isocyanates, to the catalytic compound comprised in the mixture obtained in (i), calculated as molar amount of the catalytic compound, in the mixture obtained in (i) is in the range of from 1:5 to 100:1.

25. The carbodiimide as obtained by the process according to claim 16.

26. A method of stabilizing a polymer, comprising:
adding the carbodiimide according to claim 25 to a polymer. ((SAVE))
